(19) United States
(12) Patent Application Publication
(10) Pub. No.: US 2024/0136671 A1
(43) Pub. Date: Apr. 25, 2024

(54) ELECTRODE PLATE AND BATTERY

(71) Applicant: ZHUHAI COSMX BATTERY CO., LTD., Zhuhai (CN)

(72) Inventor: Ning PENG, Zhuhai (CN)

(73) Assignee: ZHUHAI COSMX BATTERY CO., LTD., Zhuhai (CN)

(21) Appl. No.: 18/400,982

(22) Filed: Dec. 29, 2023

Related U.S. Application Data
(63) Continuation-in-part of application No. PCT/CN2022/136695, filed on Dec. 5, 2022.
Application No. PCT/CN2022/136695 is a continuation-in-part of application No. PCT/CN2022/136699, filed on Dec. 5, 2022.
Application No. PCT/CN2022/136699 is a continuation-in-part of application No. PCT/CN2022/132903, filed on Nov. 18, 2022.

(30) Foreign Application Priority Data
Nov. 18, 2021 (CN) 202111372461.8
Dec. 6, 2021 (CN) 202123044013.3
Dec. 6, 2021 (CN) 202123048902.7

(51) Int. Cl. H01M 50/531

(52) U.S. Cl. CPC H01M 50/531; H01M 10/0587

(57) ABSTRACT

An electrode plate includes: an electrode plate body and a tab, the electrode plate body includes a current collector, a first active material layer and a second active material layer; the first active material layer is provided with a groove, a bottom wall of the groove is a first functional surface of the current collector; and the tab is welded to the current collector in the groove to form a welding mark, the welding mark includes a first solder joint and a second solder joint, the first solder joint is located on the tab, the second solder joint is located on the current collector, and the first solder joint and the second solder joint are integrally fused and connected, which effectively enhances a welding strength between the tab and the current collector, so that a reliability of the electrode plate after welding is relatively high.

### CROSS-REFERENCE TO RELATED APPLICATIONS

The present application is a continuation-in-part of International Application No. PCT/CN2022/132903, filed on Nov. 18, 2022, a continuation-in-part of International Application No. PCT/CN2022/136695, filed on Dec. 5 2022, and a continuation-in-part of International Application No. PCT/CN2022/136699, filed on Dec. 5, 2022. The International Application No. PCT/CN2022/132903 claims priority to Chinese Patent Application No. 202111372461.8 filed on Nov. 18, 2021, the International Application No. PCT/CN2022/136695 claims priority to Chinese Patent Application No. 202123044013.3, filed on Dec. 6, 2021, and the International Application No. PCT/CN2022/136699 claims priority to the Chinese Patent Application No. 202123048902.7, filed on Dec. 6, 2021. All of the aforementioned applications are hereby incorporated by reference in their entireties.

### TECHNICAL FIELD

The present application relates to the field of battery technologies, and in particular, to an electrode plate and a battery.

### BACKGROUND

A lithium-ion battery has advantages of large capacity, small volume, light weight, environmental protection and the like, and is widely applied to industries such as digital electronic products and electric vehicles. A tab is generally welded on an electrode plate, and the tab is used for electrically connecting to an external circuit, so as to charge or discharge the lithium-ion battery. However, in related technologies, a welding strength between the tab and the electrode plate is low, resulting in a relatively low reliability of the electrode plate after welding.

### SUMMARY

In view of the above problems, embodiments of the present application provide an electrode plate and a battery, so as to solve problems in related technologies that after a tab is welded, a reliability of an electrode plate and an energy density of a battery are relatively low caused by a low welding strength between the tab and the electrode plate.

According to a first aspect of the present application, an electrode plate is provided, which includes: an electrode plate body and a tab, the electrode plate body includes a current collector, a first active material layer and a second active material layer, the current collector includes a first functional surface and a second functional surface that are disposed opposite to each other, the first active material layer is disposed on the first functional surface, and the second active material layer is disposed on the second functional surface; the first active material layer is provided with a groove, a bottom wall of the groove is the first functional surface; and the tab is welded to the current collector in the groove to form a welding mark, the welding mark includes a first solder joint and a second solder joint, the first solder joint is located on the tab, the second solder joint is located on the current collector, and the first solder joint and the second solder joint are integrally fused and connected.

According to a second aspect of the present application, a battery is provided, which includes at least two electrode plates that are stacked on each other, two adjacent electrode plates have opposite polarities, a separator is provided between every two adjacent electrode plates, and at least one of the at least two electrode plates is the electrode plate in the first aspect.

In the electrode plate provided by the present application, the first active material layer is disposed on a surface of the current collector, the first active material layer is provided with the groove, the tab is disposed in the groove and is welded to the current collector to form the welding mark, the welding mark includes the first solder joint and the second solder joint, the first solder joint is located on the tab, the second solder joint is located on the current collector, and the first solder joint and the second solder joint are integrally fused and connected. The first solder joint and the second solder joint are integrally fused and connected, which not only realizes an electrical connection between the tab and the current collector, but also effectively enhances a welding strength between the tab and the current collector, solving problems in related technologies that a reliability of an electrode plate after welding is relatively low caused by a low welding strength between a tab and an electrode plate.

Other configurations, other objectives, and other beneficial effects of the present application may be described in conjunction with the accompanying drawings.

### BRIEF DESCRIPTION OF THE DRAWINGS

In order to more clearly illustrate technical solutions of embodiments of the present application, drawings that need to be used in descriptions of the embodiments are briefly described below, it is obvious that the drawings in the following descriptions are some of the present application, and for a person of ordinary skill in the art, other drawings may be obtained according to these drawings without creative work.

FIG. 1 is a schematic structural diagram of an electrode plate according to the present application.

FIG. 2 is a cross-sectional view of the A-A in FIG. 1.

FIG. 3 is a top view of a welding area according to the present application.

FIG. 4 is a schematic diagram of a connection between a tab and a current collector according to the present application.

FIG. 5 is a top view of another electrode plate according to an embodiment of the present application.

FIG. 6 is a cross-sectional view of the B-B in FIG. 5.

FIG. 7 is a top view of another welding area according to an embodiment of the present application.

FIG. 8 is a schematic enlarged structural diagram of a spiral-shaped welding mark according to an embodiment of the present application.

FIG. 9 is a cross-sectional view of the A-A in FIG. 8.

FIG. 10 is a top view of a 3D microscope of a welding mark according to an embodiment of the present application.

FIG. 11 is a top view of a 3D microscope of a second protrusion according to an embodiment of the present application.

FIG. 12 is a top view of a 3D microscope of another second protrusion according to an embodiment of the present application.

FIG. 13 is a schematic structural diagram of another welding mask according to an embodiment of the present application.

FIG. 14 is a schematic structural diagram of another welding mask according to an embodiment of the present application.

FIG. 15 is a schematic structural diagram of another electrode plate according to an embodiment of the present application.

FIG. 16 is a cross-sectional view of the B-B in FIG. 15.

FIG. 17 is a schematic structural diagram of another electrode plate according to an embodiment of the present application.

FIG. 18 is a schematic diagram of another welding area according to an embodiment of the present application.

FIG. 19 is a schematic enlarged diagram of the position B in FIG. 18.

FIG. 20 is a cross-sectional view of the C-C in FIG. 19.

FIG. 21 is a top view of another welding area according to an embodiment of the present application.

FIG. 22 is a top view of another welding area according to an embodiment of the present application.

FIG. 23 is a top view of another welding area according to an embodiment of the present application.

FIG. 24 is a top view of another welding area according to an embodiment of the present application.

FIG. 25 is a schematic structural diagram of a battery cell according to an embodiment of the present application.

FIG. 26 is a schematic diagram of stacking of a positive electrode plate and a negative electrode plate according to an embodiment of the present application.

FIG. 27 is a schematic structural diagram of another battery cell according to an embodiment of the present application.

### DETAILED DESCRIPTION OF THE EMBODIMENTS

In order to make objectives, technical solutions, and advantages of the embodiments of the present application clearer, the technical solutions in the embodiments of the present application are clearly and completely described below with reference to the accompanying drawings in the embodiments of the present application. Apparently, the described embodiments are a part of the embodiments of the present application, rather than all the embodiments. Based on the embodiments of the present application, all other embodiments obtained by those of ordinary skill in the art without creative work fall within the protection scope of the present application.

In the descriptions of the present application, it should be noted that unless expressly specified and defined otherwise, the terms “mounted”, “connected” and “communicated” shall be construed broadly, for example, a fixed connection, or an indirect connection through an intermediate medium, and the indirect connection may be an internal connection between two elements or an interaction relationship between two elements. For a person of ordinary skill in the art, the specific meanings of the above terms in the present application may be understood according to specific situations.

In the descriptions of the present application, it should be understood that the orientation or positional relationship indicated by the terms “on”, “down”, “front”, “rear”, “vertical”, “horizontal”, “top”, “bottom”, “inner”, “outer” and the like is based on the orientation or positional relationship shown in the drawings, which is merely for ease of describing the present application and the simplifying description, rather than indicating or implying that the apparatus or element must have a specific orientation, or are constructed and operated in a specific orientation, and therefore cannot be understood as a limitation to the present application.

In the descriptions of the present application, it should be understood that the terms “first”, “second”, “and “third” (if present) are used to distinguish similar objects, and do not need to be used to describe a specific sequence or order. It should be understood that these terms are interchangeable under appropriate circumstances, so that the embodiments of the present application described herein can be implemented in an order other than those illustrated or described herein.

Furthermore, the terms “include” and “have” and any variations thereof are intended to cover non-exclusive inclusion, for example, processes, methods, systems, products, or maintenance tools including a series of steps or units are not necessarily limited to those steps or units clearly listed, but may include other steps or units not expressly listed or inherent to these processes, methods, products, or maintenance tools.

A lithium-ion battery is a secondary battery (i.e., a rechargeable battery) that primarily relies on lithium ions moving back and forth between a positive electrode and a negative electrode. In a charging/discharging process, the lithium ions go back and forth between the positive electrode and the negative electrode, so as to implement extraction-insertion. When the lithium-ion battery is charged, the lithium ions are extracted from the positive electrode and inserted into the negative electrode through an electrolyte, and the negative electrode is in a lithium-rich state; and it is reversed when the lithium-ion battery is discharged. As a novel energy storage battery, due to advantages of high energy, long service life, low energy consumption, pollution-free, no memory effect, low self-discharge, small internal resistance, cost-effective, less pollution, and the like, the lithium-ion battery gradually have huge advantages in applications, and is widely applied to various fields such as mobile phones, notebook computers, cameras, digital cameras, electric vehicles, energy storage or spaceflight.

The lithium-ion battery mainly includes a housing, an electrode plate, and a separator, the electrode plate includes a positive electrode plate and a negative electrode plate, the separator is disposed between the positive electrode plate and the negative electrode plate, and the separator is wound with the positive/negative electrode plate to form a battery cell. The lithium-ion battery is formed after the housing is additionally disposed outside the battery cell. A tab is connected to the electrode plate, and the tab is used for connecting to an external circuit, so as to charge or discharge a battery. The tab may be a positive tab disposed on a positive electrode plate, and the tab may also be a negative tab disposed on a negative electrode plate. Since the tab is made of an easily conductive metal material, in order to improve a current conducting capability between the tab and the electrode plate, the tab is usually welded on the electrode plate, so that the tab is electrically connected to the electrode plate. However, in related technologies, a welding strength between the tab and the electrode plate is low, resulting in a relatively low reliability of the electrode plate after welding, and further making an energy density of the battery relatively small.

In view of this, the present application provides an electrode plate, which can improve a reliability of an electrode plate by enhancing a welding strength between a tab and the electrode plate after the tab is welded to the electrode plate.

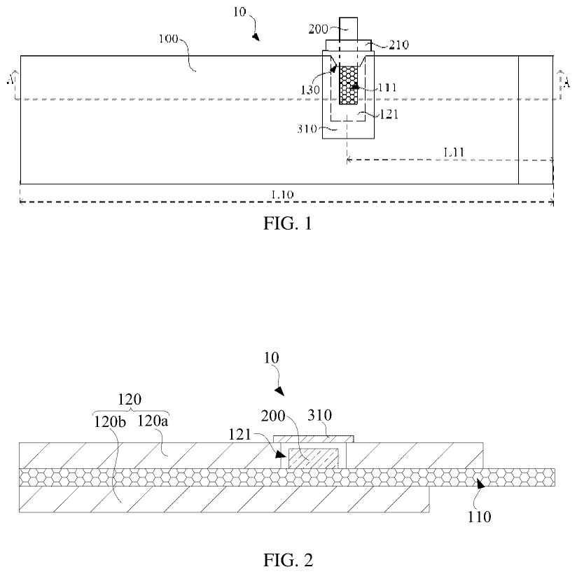

As shown in FIGS. 1, 2, 5 and 6, the present application provides an electrode plate 10, which may be used in a battery, i.e., the electrode plate 10 is a component disposed inside the battery and used for charging and discharging. The electrode plate 10 includes an electrode plate body 100 and a tab 200, the tab 200 is used for electrically connecting the electrode plate body 100 to an external circuit, the electrode plate body 100 includes a current collector 110 and an active material layer 120, the active material layer 120 includes a first active material layer 120a and a second active material layer 120b, and the first active material layer 120a and the second active material layer 120b are respectively disposed on two opposite sides of the current collector 110 to form a layered stacked electrode plate body 100.

The electrode plate 10 may be a negative electrode plate or a positive electrode plate, which may be specifically determined according to a specific selection of materials of the current collector 110 and the active material layer 120. For example, when the current collector 110 is an aluminum foil and the material of the active material layer 120 is a positive electrode active material such as a ternary material or a lithium ferrous phosphate, the electrode plate 10 is a positive electrode plate; and when the current collector 110 is a copper foil and the material of the active material layer 120 is a negative electrode active material such as graphite or silicon, the electrode plate 10 is a negative electrode plate.

The electrode plate 10 is made into a battery cell by processes such as winding, packaging, electrolyte injection, and battery formation, and a welding reliability of such a battery cell is high, which can meet a drop test from every angle.

The two opposite sides of the current collector 110 refer to two opposite functional surfaces of the current collector 110, and the two opposite functional surfaces refer to two opposite surfaces of the current collector 11 with largest areas, which are used for coating the active material layer 120. The active material layer 120 of the electrode plate 10 in the present application may only be coated on one functional surface of the current collector 110, or simultaneously coated on the two functional surfaces of the current collector 110.

The current collector 110 is made of a metal material, and the metal material is usually selected from materials such as aluminum (Al), nickel (Ni), copper (Cu) or copper-plated nickel (Ni-Cu) alloy. The first active material layer 120a and the second active material layer 120b are formed by combining materials such as an active material, a conductive agent, and an adhesive.

It should be noted that X direction in FIG. 5 is a length direction of the electrode plate 10, is also a length direction of the electrode plate body 100 and the current collector 110; the Y direction in FIG. 5 is a width direction of the electrode plate 10, is also a width direction of the electrode plate body 100 and the current collector 110, and the X direction is perpendicular to the Y direction; and a thickness direction of the electrode plate 10 (also referred to as a thickness direction of the electrode plate body 100 and the current collector 110) is perpendicular to both the Y direction and the X direction. The width direction and the length direction in the embodiments of the present application are merely for convenience of description, and do not meant to limit any size. For example, a width may be greater than, less than or equal to a length. In the present application, the X direction is also referred to as a second direction of the electrode plate, the Y direction is also referred to as a first direction of the electrode plate, and the thickness direction is also referred to as a third direction of the electrode plate.

In an example, along the third direction, the current collector 110 has a thickness of 0.001 mm to 0.02 mm.

As shown in FIGS. 5 and 6, the active material layer 120 on one of the two functional surfaces of the current collector 110 is partially removed, so as to form a groove 121 and expose a portion of the one functional surface, and an exposed functional surface is used for electrically connecting to the tab 200. In other words, in order to facilitate welding of the tab 200, the groove 121 is provided on the first active material layer 120a on one surface of the electrode plate body 100. For example, an active material coated in a specific region on a surface of the first active material layer 120a is scraped by using techniques such as laser cleaning, foaming, or machinery, so that a surface of the current collector 110 covered by the first active material layer 120a at the specific region is leaked out, so as to weld the tab 200.

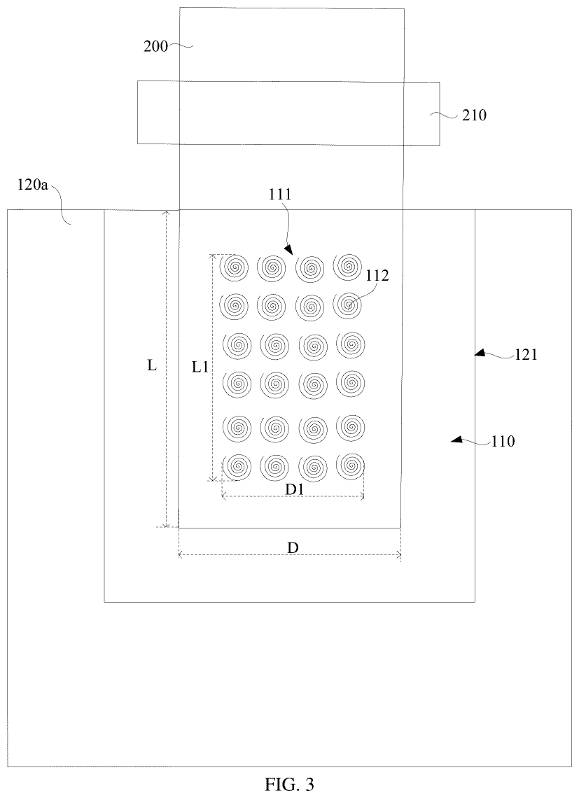

For example, as shown in FIGS. 2 and 3, the first active material layer 120a is provided with the groove 121, a bottom wall of the groove 121 is a surface of the current collector 110, and the tab 200 is disposed in the groove 121 and is welded to the current collector 110, so as to form a welding mask 112 (also referred to as a solder joint group). On the current collector 110, a projection of the groove 121 is within a projection of the second active material layer 120b, ensuring that a surface, away from the groove 121, of the current collector 110 is completely covered by the second active material layer 120b.

In an example, the tab 200 is disposed in a middle of the groove 121.

In an embodiment of the present application, the tab 200 is classified into a positive tab and a negative tab, and the positive tab and the negative tab are respectively welded to different electrode plate bodies 100. In order to improve a strength generated after the tab 200 is welded to the current collector 110, in the present application, a thickness of the tab 200 along the third direction is set within an appropriate range, which not only increases a welding strength between the tab 200 and the current collector 110, but also avoids a change in a thickness of a battery caused by a thickness of the tab 200 being too large. For example, along the third direction, when the tab 200 is the positive tab, a thickness of the positive tab 200 is 5 to 20 times a thickness of the current collector 110; and when the tab 200 is the negative tab, a thickness of the negative tab 200 is 10 to 40 times the thickness of the current collector 110. A purpose of such an arrangement is to effectively improve a welding reliability between the tab 200 and the current collector 110, and ensure an ability to pass a current through the tab 200.

In an embodiment of the present application, in order to improve a conduction capability of the tab 200, generally, a size of the tab 200 is set to be relatively large. For example, along the third direction, a thickness of the tab 200 is 0.01 mm to 0.5 mm; along the second direction, a length of the tab 200 is 1 mm to 12 mm; and along the first direction, a length of the tab 200 is 5 mm to 50 mm. For another example, along the third direction, the thickness of the tab 200 is 0.01 mm to 1 mm; along the second direction, the length of the tab 200 is 1 mm to 20 mm; and along the first direction, the length of the tab 200 is 5 mm to 100 mm.

In an embodiment of the present application, in order to ensure a conduction capability of the tab 200 and prevent the tab 200 from being welded through, along the third direction, a thickness of the tab 200 is greater than or equal to a depth of the groove 121. The thickness of the tab 200 is in direct proportion to the conduction capability of the tab 200 within a reasonable size range, i.e., the greater the thickness of the tab 200, the stronger the conduction capability of the tab 200. Meanwhile, the thickness of the tab 200 is increased, which can also effectively prevent the tab 200 from being welded through during welding, improving a welding yield.

The tab 200 is a metal conductor that leads a positive electrode or a negative electrode out of a battery, i.e., the tab 200 corresponding to the positive electrode or the negative electrode of the battery is a contact point during charging/discharging. The contact point is not a copper sheet that is commonly seen in an outer surface of a battery, but a component provided inside the battery for electrical connection between an electrode plate and a protection circuit. The tab 200 is mainly made of three materials, and is usually made of aluminum (Al), nickel (Ni), copper (Cu) or copper-plated nickel (Ni-Cu) alloy and other materials, which are both formed by compounding a film and a metal strip. A surface of the tab 200 has a special coating for improving a laser absorptivity of the tab 200.

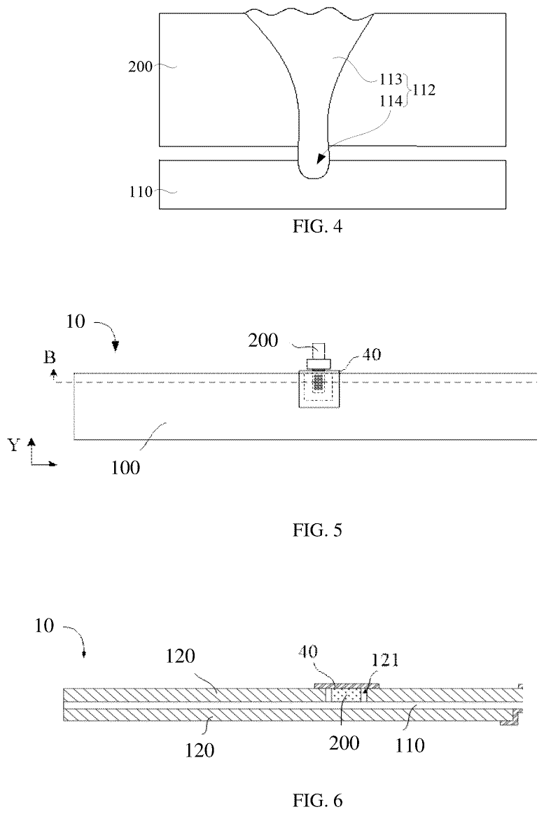

As shown in FIG. 4, the welding mask 112 (i.e., the solder joint group) includes a first solder joint 113 and a second solder joint 114, the first solder joint 113 is located on the tab 200, the second solder joint 114 is located on the current collector 110, and the first solder joint 113 and the second solder joint 114 are integrally fused and connected.

In the present application, the tab is welded to the current collector by using laser welding, so that along the thickness direction of the current collector (i.e., the third direction), a molten welding pool on the tab completely penetrates through the tab to form the first solder joint, and the second solder joint is formed on the current collector through at least a part of the melted molten welding pool, i.e., the first solder joint and the second solder joint are integrally fused and connected, so that the tab and the current collector are electrically connected, and a welding strength between the tab and the current collector is effectively enhanced, solving problems in related technologies that a relatively low reliability of an electrode plate and a relatively low energy density of a battery after welding caused by a low welding strength between a tab and an electrode plate.

The welding mark 112 formed after the tab 200 is welded to the current collector 110 may be described in detail below.

In related technologies, the tab 200 is connected to the current collector 110 by ultrasonic welding, and in the ultrasonic welding, a welding head for the ultrasonic welding is in contact with a side, away from the tab 200, of the current collector 110, and pressurized vibration is performed, so as to weld the tab 200 and the current collector 110 together. Using the ultrasonic welding, the active material layers 120 on the two functional surfaces, at a junction between the current collector 110 and the tab 200, of the current collector 110 need to be cleaned away, which results in a relatively low energy density of the electrode plate 10. In addition, in a process of the ultrasonic welding, the welding head for the ultrasonic welding may be worn, and therefore, the welding head needs to be replaced regularly, so that a workload of workers is increased, and it is easy to cause a problem of faulty welding or over-welding between the tab 200 and the current collector 110 caused by the welding head being worn, affecting a performance of a battery. Moreover, using the ultrasonic welding may form a relatively sharp needle-like welding protrusion, and when the electrode plate 10 is assembled into a battery, it is easy to pierce a separator adjacent to the needle-like welding protrusion, causing a short circuit between a positive electrode plate and a negative electrode plate, and further causing a safety accident.

In view of this, in the embodiments of the present application, the tab 200 and the current collector 110 may be connected by laser welding. There is no need to use a welding head during the laser welding, and therefore, the above problems of the ultrasonic welding may be effectively avoided. In a process of the laser welding, the laser is irradiated on the tab 200 from a side, away from the current collector 110, of the tab 200, so as to weld the tab 200 and the current collector 110. After the laser welding is completed, a plurality of welding marks 112 disposed at intervals are formed at a welding position between the tab 200 and the current collector 110, and a welding area 111 is formed by the plurality of welding marks 112 together.

The laser is irradiated from the side, away from the current collector 110, of the tab 200 for welding, and therefore, there is no need to clean the active material layer 120 on a side, away from the tab 200, of the current collector 110, so that an energy density of the electrode plate 10 is relatively high.

As shown in FIG. 1 and FIG. 3, the welding area 111 is disposed on a surface of the current collector 110 in the groove 121, the welding area 111 is in communication with the groove 121, and the tab 200 is welded on the welding area 111 through the welding mark 112.

As shown in FIG. 3 and FIG. 4, there are a plurality of welding marks 112, each welding mark 112 includes a first solder joint 113 and a second solder joint 114, the first solder joint 113 is located on the tab 200 and is formed by a molten welding pool of the tab 200, and the first solder joint 113 penetrates through the tab 200. The second solder joint 114 is located on the current collector 110 and is formed by a molten welding pool of the current collector 110, and a depth of the second solder joint 114 is 50% to 100% of a thickness of the current collector 110 along the third direction, so that the tab 200 may be electrically connected to the current collector 110, making a current flow back and forth between the electrode plate body 100 and an external circuit through the tab 200.

A process of welding the tab 200 to the current collector 110 by the laser welding may be described below.

Specifically, the first active material layer 120a and the second active material layer 120b are first coated on two opposite surfaces of the current collector 110, the groove 121 is disposed on the first active material layer 120a on a surface of the current collector 110, and the welding area 111 is formed on the surface of the current collector 110 exposed in the groove 121. The current collector 110 and the second active material layer 120b jointly serve as a bottom layer. The tab 200 is placed above the current collector 110, and the tab 200 is fixed in the groove 121 by a tool such as a clamp (not labeled in the figure), so that a connection between the tab 200 and the current collector 110 is in a compacted state. A pulse width of the laser (not labeled in the figure) is set to be less than or equal to 1 ms, a welding time is set to be less than or equal to 5 seconds, a welding trajectory (including but not limited to a spiral point, a sine line, a dot, a character, and the like) is set. A laser beam is struck on a surface, away from the current collector 110, of the tab 200 through the clamp, and a shape of a specific welding trajectory is formed on the surface. The second active material layer 120b on another surface, away from the tab 200, of the current collector 110 is not affected.

The welding mark 112 is the molten welding pool formed after the tab 200 and the current collector 110 are heated. After the laser welding is completed, the tab 200 is completely penetrated through, i.e., a depth of the molten welding pool on the tab 200 is a thickness of the tab 200, and the first solder joint 113 is formed by the molten welding pool on the tab 200. At least a part (i.e., part or all) of the current collector 110 are melted to form the molten welding pool, the second solder joint 114 is formed by the molten welding pool on the current collector 110, and along the third direction, a depth of the second solder joint 114 is 50% to 100% of a thickness of the current collector. The second solder joint 114 may forms a protrusion toward a direction away from a surface of the current collector 110 (not shown in the figure), and the protrusion may be covered by the second active material layer 120b. The first solder joint 113 and the second solder joint 114 are integrally fused and connected, so that the tab 200 is electrically connected to the current collector 110. Such an arrangement has an advantage that a welding strength between the tab 200 and the current collector 110 may be effectively enhanced to improve a reliability of the electrode plate 10 after welding and reduce an impact on the second active material layer 120b on a back surface of the welding area 111.

In the present application, the welding mark 112 may be embedded into a crystal glue, after the crystal glue is solidified, the crystal glue is ground and polished through an abrasive paper, and then the crystal glue is corroded with a hydrofluoric acid solution with a concentration of 0.5%, a nitric acid solution with a concentration of 25%, or a sulfuric acid with a concentration of 10% to 20%, and finally a size of a depth of fusion of the welding mark 112 is observed and measured through a microscope.

In an embodiment of the present application, as shown in FIG. 1 and FIG. 3, after the tab 200 is welded to the current collector 110, a portion of a structure of the tab 200 is located inside the groove 121 and overlaps with the current collector 110, and another portion of the structure of the tab 200 is located outside the groove 121. In order to improve a reliability of the tab 200 after welding to the current collector 110, in this embodiment, a size of an area of the welding area 111 is increased, so that the reliability of the tab 200 after welding is improved, for example, along the second direction, a length D1 of the welding area 111 is set to be 50% to 100% of a length D of the tab 200, and along the first direction, a length L1 of the welding area 111 is set to be 50% to 100% of a length of an overlapping portion L that the tab 200 overlaps with the current collector 110.

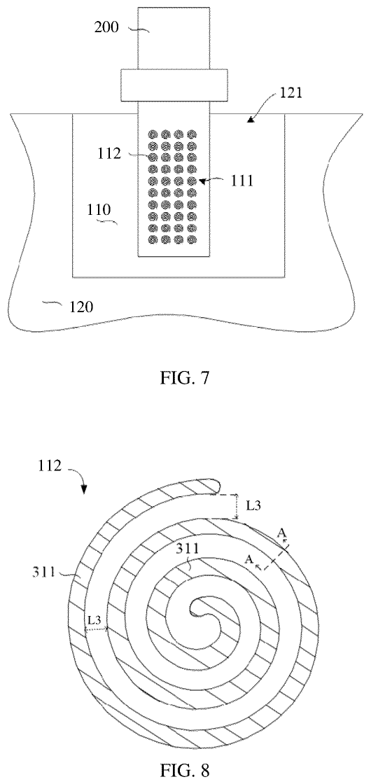

In an embodiment of the present application, as shown in FIG. 7, when there are a plurality of welding marks 112, the welding area 111 is formed by the plurality of welding marks 112 together. The plurality of welding marks 112 are disposed at intervals in the welding area 111, and a single welding mark 112 is relatively small, so that an input energy required to form each welding mark 112 is relatively small, avoiding a phenomenon of over-welding or welding through the current collector 110 caused by an excessive heat, and further ensuring a performance of the electrode plate 10.

At least a part of one welding mark 112 is located on a surface, away from the current collector 110, of the tab 200, and protrudes toward a side away from the current collector 110. Therefore, when the tab 200 is welded to the current collector 110, the welding may be carried out from a side, away from the current collector 110, of the tab 200, rather than from a side, away from the tab 200, of the current collector 110, reducing an impact on the active material layer 120 on the side, away from the tab 200, of the current collector 110.

In an embodiment of the present application, as shown in FIG. 8, on the tab 200, a shape of a projection of the welding mark 112 located on a side, away from the current collector 110, of the tab 200 may be spiral, a spiral welding mark 112 includes a plurality of spiral lines 311, and one turn of the spiral welding mark 112 is one spiral line 311. There is a distance between two adjacent spiral lines 311, and an arrangement of the distance facilitates heat dissipation in a welding process, avoiding over-welding or welding through and the like caused by heat accumulation.

The number of spiral lines of the spiral welding mark 112 ranges from 1 to 10. The number of spiral lines of the welding mark 112 may be set to be one, two, three four, five, eight, or ten according to actual situations, which is not limited in the present application. When the number of spiral lines of the spiral welding mark 112 is greater than 10, the welding mark 112 is too large, so that an input energy required to form the welding mark 112 is relatively high, which leads to an impact on the active material layer 120 at the welding area 111.

As shown in FIG. 8, in each spiral welding mark 112, a distance between any two adjacent spiral lines 311 is L3, and the distance L3 between any two adjacent spiral lines 311 ranges from 0.01 mm to 3 mm. For example, the distance L3 may be 0.5 mm, 1 mm, 1.5 mm, 2 mm, 2.5 mm, or 3 mm, and the like, which is not limited in the embodiment. When the distance L3 is less than 0.01, the distance between any two adjacent spiral lines 311 is too close, which results in poor heat dissipation in the welding process. When the distance L3 between any two adjacent spiral lines 311 is greater than 3 mm, the distance between any two adjacent spiral lines 311 is too large, resulting in a relatively small effective welding area between the tab 200 and the current collector 110, and further resulting in a relatively low welding strength.

In each spiral welding mark 112, a distance between a spiral center of the welding mark 112 and an outer edge of an outermost spiral line 311 of the welding mark 112 may range from 0.05 mm to 2.5 mm. The distance between the spiral center of the welding mark 112 and the outer edge of the outermost spiral line 311 of the welding mark 112 is a distance from a center of the welding mark 112 to an outer edge of the welding mark 112. For example, the distance between the spiral center of the welding mark 112 and the outer edge of the outermost spiral line 311 of the welding mark 112 may be 0.05 mm, 0.25 mm, 0.5 mm, 1 mm, 1.5 mm, or 2.5 mm, and the like, which is not limited in the embodiment. When the distance between the spiral center of the welding mark 112 and the outer edge of the outermost spiral line 311 of the welding mark 112 is less than 0.05 mm, the welding mark 112 is too small, so that a contact area between the tab 200 at the welding mark 112 and the current collector 110 is too small, leading to inability to form an effective welding pulling force, and further resulting in a relatively low welding strength. When the distance between the spiral center of the welding mark 112 and the outer edge of the outermost spiral line 311 of the welding mark 112 is greater than 2.5 mm, the welding mark 112 is too large, so that an input energy required to form the welding mark 112 is relatively high, which leads to an impact on the active material layer 120 at the welding area 111.

In a possible implementation, as shown in FIG. 8 and FIG. 9, the welding mark 112 located on a side, away from the current collector 110, of the tab 200 protrudes toward a side away from the current collector 110, so as to form a first protrusion 312a. A shape of a projection of the first protrusion 312a on the tab 200 may be spiral. On the side, away from the current collector 110, of the tab 200, the first protrusion 312a is formed by various spiral lines 311 of the welding mask 112 together. There is a planar structure between the two adjacent spiral lines 311, and the planar structure is a surface of the tab 200 without forming the spiral line 311, facilitating heat dissipation in a process of forming the welding mask 112.

In a possible implementation, along the thickness direction of the electrode plate body 100 (i.e., the third direction), the welding mark 112 penetrates through the tab 200, and the welding mark 112 is located in a partial region, close to the tab 200, of the current collector 110. A depth of fusion of the laser is greater than a thickness of the tab 200, and is less than a sum of thicknesses of the tab 200 and the current collector 110. Therefore, the welding mark 112 is formed on the side, away from the current collector 110, of the tab 200, while there is no welding mark 112 on a surface, away from the tab 200, of the current collector 110, and the surface, away from the tab 200, of the current collector 110 is a plane, so that an impact of the welding mark 112 on the active material layer 120 on the side, away from the tab 200, of the current collector 110 is relatively small.

For example, as shown in FIG. 4, along the third direction, the first solder joint 113 penetrates through the tab 200, the second solder joint 114 does not penetrate through the current collector 110, and an end of the second solder joint 114 is located in a partial region, close to the tab 200, of the current collector 110.

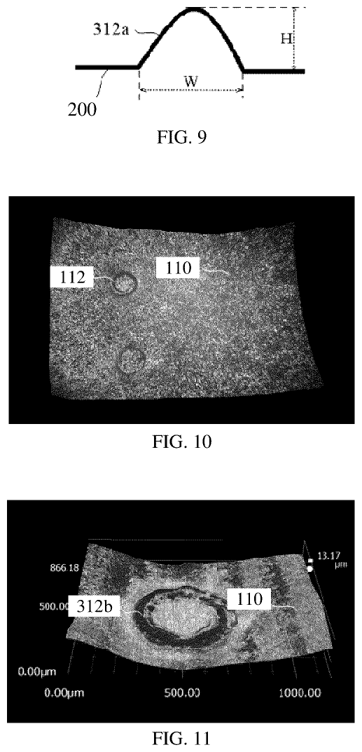

In a possible implementation, as shown in FIG. 10 to FIG. 12, along the thickness direction of the electrode plate body 100, the welding mark 112 penetrates through the tab 200 and the current collector 110. Due to heat accumulation in a welding process, the depth of fusion of the laser is gradually increased as the welding process, and after a certain degree is reached, the depth of fusion of the laser exceeds a sum of the thicknesses of the tab 200 and the current collector 110, so that the welding mask 112 is formed on the side, away from the tab 200, of the current collector 110. Therefore, the welding mark 112 can both be observed on a surface, away from current collector 110, of the tab 200 and a surface, away from the tab 200, of the current collector 110. The welding mark 112 located on the side, away from the tab 200, of the current collector 110 is covered by the active material layer 120, so that an impact of the welding mark 112 on a separator on the side, away from the tab 200, of the current collector 110 can be reduced. The welding mark 112 located on the side, away from the tab 200, of the current collector 110 protrudes toward the side away from the tab 200, so as to form a second protrusion 312b.

For example, along the third direction, the first solder joint 113 penetrates through the tab 200, and the second solder joint 114 penetrates through the current collector 110; and at least a part of one second solder joint 114 is located on a surface of the current collector 110 and protrudes toward the side away from the tab 200, so as to form the second protrusion 312b.

It should be understood that, regardless of whether the first protrusion 312a or the second protrusion 312b, morphology on the welding mark 112 is a protrusion and a recess having an irregular shape.

In a possible implementation, in a same welding mark 112, along the third direction, a portion of the welding mark 112 penetrates through the tab 200 and the current collector 110; and another portion of the welding mark 112 penetrates through the tab 200 and is located in a partial region, close to the tab 200, of the current collector 110. For example, the welding mark 112 includes an outer edge portion and a middle portion, and the outer edge portion is annularly disposed on an outer side of the middle portion. Along the third direction, the outer edge portion penetrates through the tab 200 and the current collector 110, and the outer edge portion located on the side, away from the tab 200, of the current collector 110 protrudes toward the side away from the tab 200. In the welding process, the current collector 110 is slightly deformed, and a pressing effect is poor, which results in a defocus amount of the laser welding is gradually reduced, so that during a welding tail end, the welding mark 112 is formed on the side, away from the tab 200, of the current collector 110. Therefore, the outer edge portion of the welding mark 112 can be observed on the surface, away from the tab 200, of the current collector 110. The outer edge portion located on the side, away from the tab 200, of the current collector 110 protrudes toward the side away from the tab 200, so as to form the second protrusion 312b. The outer edge portion located on the side, away from the tab 200, of the current collector 110 is covered by the active material layer 120, so that an impact of the outer edge portion on a separator on the side, away from the tab 200, of the current collector 110 can be reduced.

In a possible implementation, along the third direction, the middle portion penetrates through the tab 200, and the middle portion is located in a partial region, close to the tab 200, of the current collector 110. Therefore, the middle portion of the welding mark 112 cannot be observed on the surface, away from the tab 200, of the current collector 110.

As for the outer edge portion and the middle portion of the welding mark 112, the first solder joint 113 includes a first outer edge portion and a first middle portion, the second solder joint 114 includes a second outer edge portion and a second middle portion, and the first outer edge portion and the second outer edge portion are communicated to form the outer edge portion of the welding mark 112, and the first middle portion and the second middle portion are in communicated to form the middle portion of the welding mark 112.

In a possible implementation, in one welding mark 112, the outer edge portion penetrates through the tab 200 and the current collector 110, and along the third direction, the outer edge portion on a side, away from the tab 200, of the current collector 110 overlaps with the outer edge portion on a side, away from the current collector 110, of the tab 200, i.e., on the current collector 110, a projection of the outer edge portion on the side, away from the tab 200, of the current collector 110 overlaps with a projection of the outer edge portion on the side, away from the current collector 110, of the tab 200.

In a possible implementation, in one welding mark 112, a portion of the outer edge portion penetrates through the tab 20 and the current collector 11.

In an implementation of simultaneously forming the first protrusion 312a and the second protrusion 312b, the first protrusion 312a on a surface, away from the current collector 110, of the tab 200 is formed on the welding mark 112, and the second protrusion 312b on a surface, away from the tab 200, of the current collector 110 is formed on the welding mark 112, so that there is a relatively large welding pulling force between the tab 200 and the current collector 110, resulting in a relatively high welding reliability.

In an embodiment of the present application, the first protrusion 312a and the second protrusion 312b may be disposed opposite to each other along the third direction. On the current collector 110, a projection of the second protrusion 312b is within a projection of the first protrusion 312a. As shown in FIGS. 8, 11 and 12, the second protrusion 312b may be disposed opposite to an outer spiral line of the first protrusion 312a (equivalent to one implementation of the outer edge portion), and the outer spiral line may be an outermost spiral line of the first protrusion 312a, or the outer spiral line may also be any one of the spiral lines 311 located between the outermost spiral line and an innermost spiral line of the first protrusion 312a, for example, the outer spiral line is a secondary outer spiral line. As shown in FIG. 11, a shape of the second protrusion 312b is almost a circular ring; or as shown in FIG. 12, a shape of the second protrusion 312b is almost a circular ring, and the circular ring has a plurality of breakpoints without protrusions, and at the breakpoint, the welding mask 112 does not penetrate through the current collector 110, so that the current collector 110 is a plane, i.e., the current collector 110 at the breakpoint is a planar structure. The second protrusion 312b may also be formed at other positions of the welding mark 112, i.e., except for the second protrusion 312b being formed on the current collector 110 in a form of a protrusion on the outer edge portion, the second protrusion 312b may also be formed on the current collector 110 in a form of a protrusion on other portions of the welding mark 112. The shape of the second protrusion 312b may also be spiral, which is not limited in the present application.

In an embodiment of the present application, along the third direction, a protrusion height of the second protrusion 312b is less than or equal to a protrusion height of the first protrusion 312a. Therefore, there is a relatively small impact of the second protrusion 312b on the active material layer 120 on the surface, away from the tab 200, of the current collector 110.

In an embodiment of the present application, when a shape of a projection, on the tab 200, of the welding mark 112 located on the side, away from the current collector 110, of the tab 200 is spiral, as shown in FIGS. 8 and 9, in any one of the spiral lines 311 of the welding mark 112, along the third direction, a height of the first protrusion 312a is H, and a width of the first protrusion 312a is W. A ratio of the width W of the first protrusion 312a to the height H of the first protrusion 312a is greater than or equal to 1. For example, the ratio of the width W of the first protrusion 312a to the height H of the first protrusion 312a is 1, 1.2, 1.5, or 2, and the like, which is not limited in the embodiment. When the ratio of the width W of the first protrusion 312a to the height H of the first protrusion 312a is less than 1, the shape of the first protrusion 312a is relatively sharp, making it easy for the first protrusion 312a to pierce a separator adjacent to the first protrusion 312a in a battery, and further affecting safety of a battery.

In any one of the spiral lines 311 of the welding mark 112, the width W of the first protrusion 312a is in a range of 0.01 mm to 0.2 mm. For example, the width W of the first protrusion 312a may be 0.01 mm, 0.05 mm, 0.1 mm, 0.15 mm, or 0.2 mm, and the like, which is not limited in this embodiment. When the width W of the first protrusion 312a is less than 0.01 mm, a welding area between the tab 20 at the first protrusion 312a and the current collector 110 is relatively small, so that a welding strength is relatively low. When the width W of the first protrusion 312a is greater than 0.2 mm, an input energy required to form the first protrusion 312a is relatively high, affecting the active material layer 120 near the welding mask 112.

In any one of the spiral lines 311 of the welding mark 112, the height H of the first protrusion 312a is less than or equal to 0.1 mm. For example, the height H of the first protrusion 312a may be 0.01 mm, 0.03 mm, 0.05 mm, 0.07 mm, 0.09 mm, or 0.1 mm, and the like, which is not limited in this embodiment. When the height H of the first protrusion 312a is greater than 0.1 mm, the first protrusion 312a is relatively high, making it easy for the first protrusion 312a to pierce a separator adjacent to the first protrusion 312a in a battery, and further causing a short circuit between positive and negative electrodes of a battery.

In an embodiment of the present application, a size parameter of the second protrusion 312b may be set with reference to a range of a size parameter of the first protrusion 312a. For example, when the second protrusion 312b also includes a plurality of spiral lines 311, in any one of the spiral lines 311, a ratio of a width of the second protrusion 312b to a height of the second protrusion 312b is greater than or equal to 1; a height of the second protrusion 312b is less than or equal to 0.1 mm; and a width of the second protrusion 312b ranges from 0.01 mm to 0.2 mm.

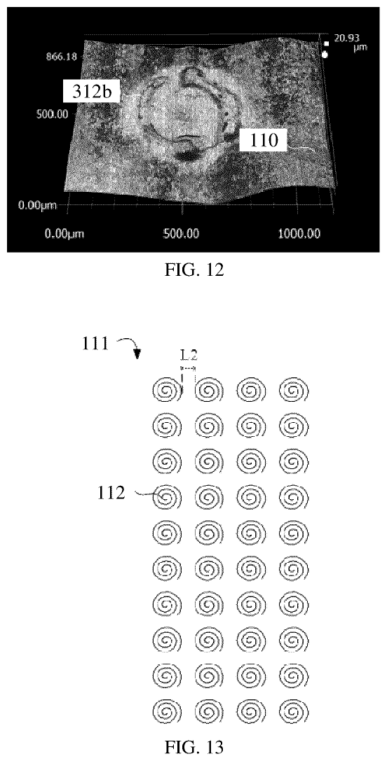

In an embodiment of the present application, as shown in FIG. 13, the welding area 111 is provided with a plurality of welding marks 112, a distance L2 between outermost spiral lines 311 of any two adjacent spiral welding marks 112 may be less than or equal to 5 mm, and the distance L2 is a distance between the two welding marks 112. For example, the distance L2 between the two adjacent welding marks 112 may be 0.5 mm, 1 mm, 2 mm, 3 mm, 4 mm, or 5 mm, and the like, which is not limited in this embodiment. When the distance L2 between the two adjacent welding marks 112 is greater than 5 mm, the welding marks 112 in the welding area 111 are relatively dispersed, and the number of the welding marks 112 is relatively small, resulting in a relatively small effective connection area between the tab 200 and the current collector 110, and further resulting in a relatively low connection strength between the tab 200 and the current collector 110.

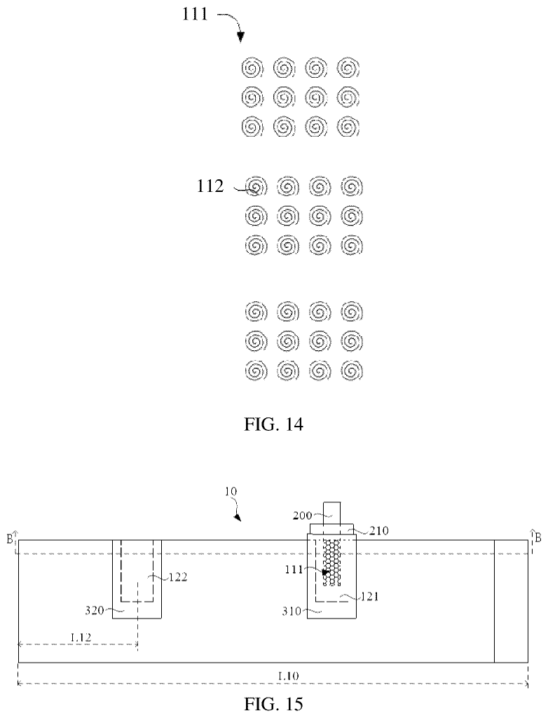

In an embodiment of the present application, as shown in FIG. 14, a plurality of welding marks 112 may be disposed in a matrix. The plurality of welding marks 112 may be disposed in a matrix with a plurality of rows and a plurality of columns. The number of the rows in the matrix may be 2, 3, 4, 5, or 10, and the like, which is not limited in the present application. The number of the columns in the matrix may be 2, 3, 4, 5, or 10, and the like, which is not limited in the present application. As shown in FIG. 13, the matrix may be a matrix with 10 rows*4 columns, there are 40 spiral welding marks 112 in the matrix. Matrix arrangement is attractive and tidy, and the plurality of welding marks 112 are well distributed, so that a welding evenness of the welding area 111 is better.

In an embodiment of the present application, as shown in FIG. 14, the plurality of welding marks 112 may also be disposed into at least two matrices, and a plurality of matrices may be disposed at intervals along the width direction (i.e., the first direction) or the length direction (i.e., the second direction) of the electrode plate 10. For example, the number of the matrices formed by the plurality of welding marks 112 may be 2, 3, or 4, and the like, which is not limited in the present application. The number of the welding marks 112 in each matrix may be the same, or may be different. There is a gap between two adjacent matrices. As shown in FIG. 14, there are three matrixes, in each matrix, the plurality of welding marks 112 are disposed in 3 rows*4 columns, i.e., the number of the plurality of welding marks 112 is 12, and therefore, the total number of the welding marks 112 in the three matrixes is 36.

Exemplarily, when the matrix shown in FIG. 13 is formed by the plurality of welding marks 112, the tab 200 is first placed into the groove 121, the tab 200 is pressed by a clamp, and then laser welding is performed to form a plurality of spiral welding mark 112. A distance between a spiral center of the welding mark 112 and an outer edge of an outermost spiral line 311 of the welding mark 112 is 0.25 mm, an interval between two adjacent welding marks 112 is 0.5 mm, a width W of one spiral line 311 of the first protrusion 312a is 0.05 mm, and the number of the spiral lines 311 is 4. A continuous laser welding is performed on a surface of the tab 200e, a welding time for forming a single welding mark 112 is 0.05 s, 10*4 welding marks 112 are formed, and an area of the welding area 111 is 3.5 mm*9.5 mm.

In addition, in order to increase a welding strength between a tab and a current collector to improve a reliability of an electrode plate after welding, another form of welding mark 112 may also be used, which may be described in detail below.

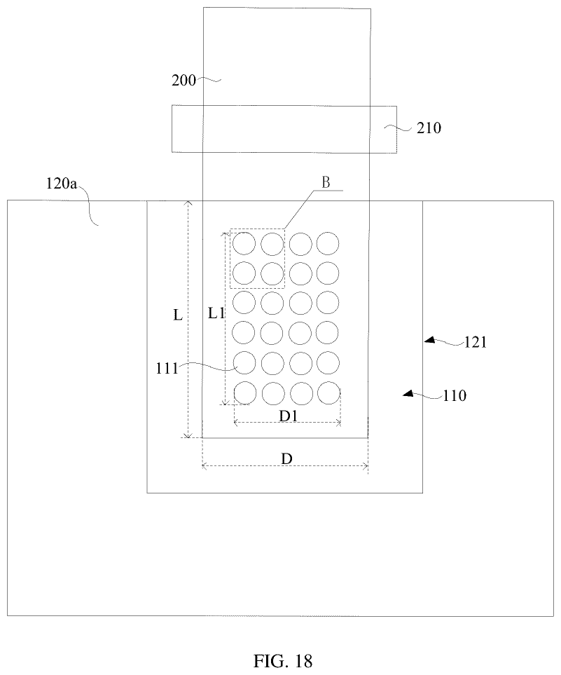

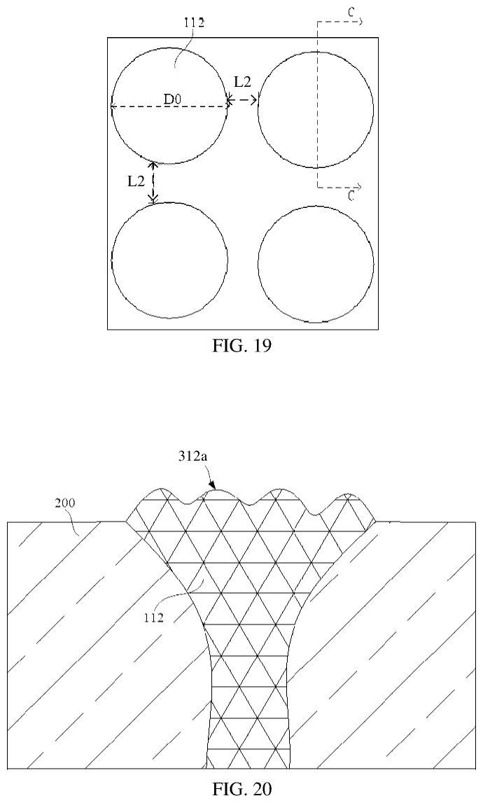

As shown in FIG. 18 and FIG. 19, at least one active material layer 120 (for example, the first active material layer 120a) has a groove 121, a bottom wall of the groove 121 is the current collector 110, the tab 200 is disposed in the groove 121, and the tab 200 is welded to the current collector 110 to form the welding mask 112. A shape of the welding mark 112 is a circle, and a diameter of the circle ranges from 0.03 mm to 2 mm.

As shown in FIGS. 2 and 17 to 19, the tab 200 is disposed in the groove 121, and the tab 200 may be welded to the current collector 110 at the bottom wall of the groove 121. There are a plurality of welding marks 112, and a shape of the welding mark 112 is a circle. A diameter DO of the circle corresponding to each welding mark 112 ranges from 0.03 mm to 2 mm. The welding mark 112 is a molten welding pool formed after the tab 200 and the current collector 110 are heated, and the welding mark 112 penetrates through the tab 200, and a portion of the welding mark 112 is accommodated inside the current collector 110. Along the third direction, a depth of the portion of the welding mark 112 located inside the current collector 110 is 50% to 100% of a thickness of the current collector 110, so that the tab 200 may be electrically connected to the current collector 110, and a current can flow back and forth between the electrode plate body 100 and an external circuit through the tab 200.

In some embodiments, the tab 200 is welded to the current collector 110 by laser welding. Specifically, the first active material layer 120a and the second active material layer 120b are first coated on two opposite surfaces of the current collector 110, the groove 121 is provided on the first active material layer 120a on a surface of the current collector 110, the welding area 111 is formed on a surface of the current collector 110 exposed in the groove 121, and the second active material layer 120b is coated on another surface, away from the groove 121, of the current collector 110. The current collector 110 and the second active material layer 120b jointly serve as a bottom layer. The tab 200 is placed in the groove 121 above the current collector 110, and the tab 200 is fixed in the groove 121 by tools such as a clamp (not shown in the figures), so that a connection between the tab 200 and the current collector 110 is in a compacted state.

A pulse width of the laser (not labeled in the figures) is set to be less than or equal to 1 ms, a welding time is set to be less than or equal to 5 seconds, a welding trajectory is set to be a circle, and a diameter DO of the circle corresponding to the welding mark 112 ranges from 0.03 mm to 2 mm. A reason for limiting a maximum numerical value of the diameter to 2 mm is that when the diameter of the circle corresponding to the welding mark 112 exceeds 2 mm, a thermal accumulation of the laser welding is relatively large, which may have an adverse effect on an active material on a back surface of the welding mark 112, so that the active material on the back surface of the welding mark 112 has a welding back mark. A laser beam is struck on a surface, away from the current collector 110, of the tab 200 through the clamp, and a plurality of welding marks 112 having a circular shape are formed on the surface. A distance L2 between the circles corresponding to various welding mark 112 ranges from 0.001 mm to 5 mm. The second active material layer 120b on the other side, away from the tab 200, of the welding mask 112 is not affected.

After the laser welding is completed, the tab 200 is completely penetrated through, i.e., a depth of a molten pool at the tab 200 is a thickness of the tab 200, and along the thickness direction, the current collector 110 is partially or completely melted to form a molten pool, and a depth of the molten pool at the current collector 110 is 10% to 100% of a thickness of the current collector 110. Such an arrangement may ensure a reliable connection between the tab 200 and the current collector 110, and reduce an impact of the welding on the second active material layer 120b covered on a surface, away from the tab 200, of the current collector 110. Advantages of such an arrangement are that a welding strength between the tab 200 and the current collector 110 may be effectively increased, and a reliability of the electrode plate 10 after welding is improved. In addition, Advantages of the welding mark 112 with the circular shape are that a stress state is consistent when the welding mark is subjected to tension in different directions, and there is no weak area, so that a battery cell made of the electrode plate 10 after welding can meet requirements for a drop test at various angles.

As shown in FIG. 18 to FIG. 20, there are a plurality of welding marks 112, and the welding marks 112 are disposed at intervals, and a distance L2 between two adjacent welding marks 112 ranges from 0.001 mm to 5 mm. Each welding mark 112 is disposed in a form of a rectangular array or a circular array. At least a part of one welding mark is located on a surface, away from the current collector 110, of the tab 200 and protrudes toward a side away from the current collector 110, so as to form a first protrusion 312a, and a height of the first protrusion 312a is equal to or less than 50% of the diameter of the circle corresponding to the welding mark 112.

In some embodiments, there are a plurality of welding marks 112 in the welding area 111, and the welding marks 112 are disposed at intervals in the welding area 111. A specific arrangement manner of the welding marks 112 may be in a form of a rectangular array, a circular array, a rhombic array, a triangular array, or characters, and the like.

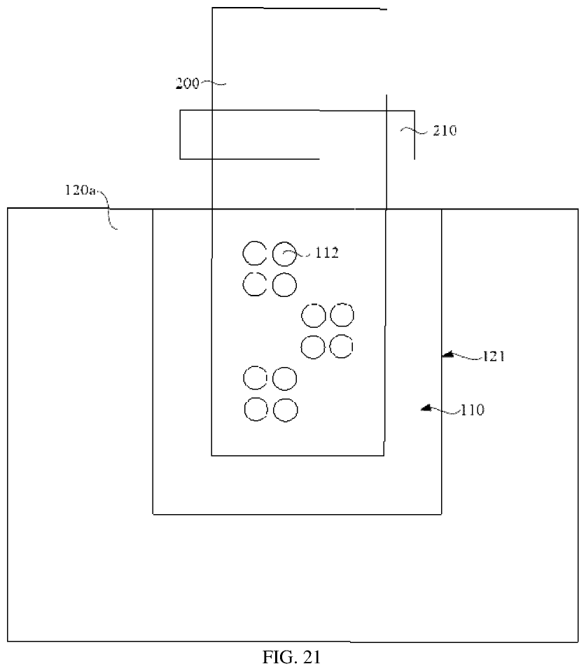

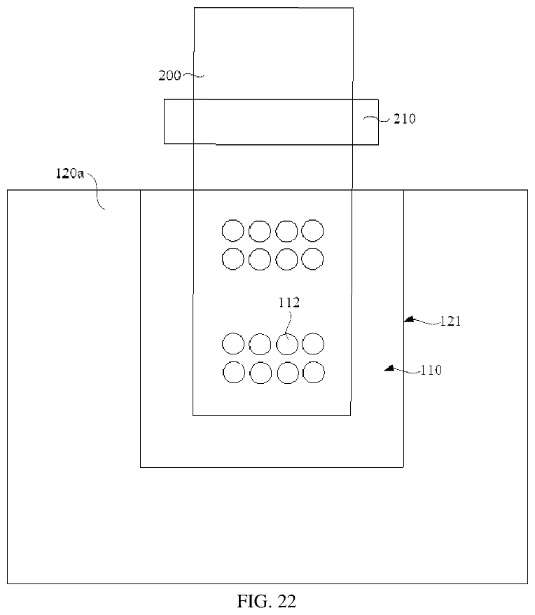

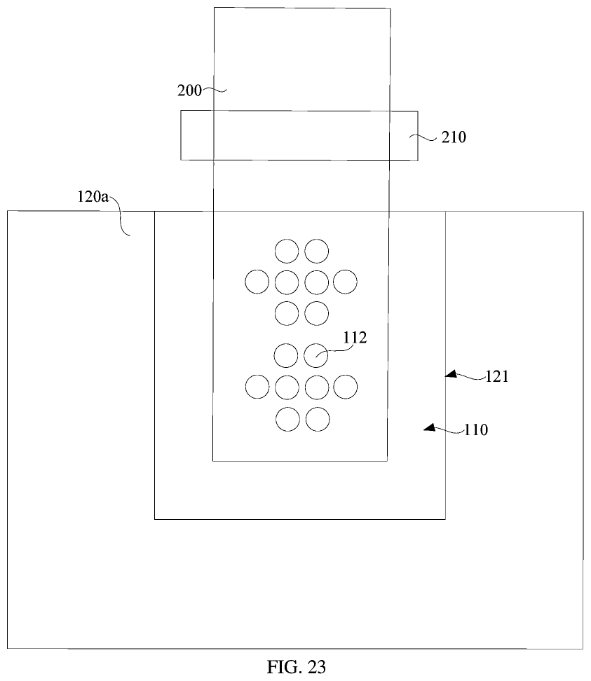

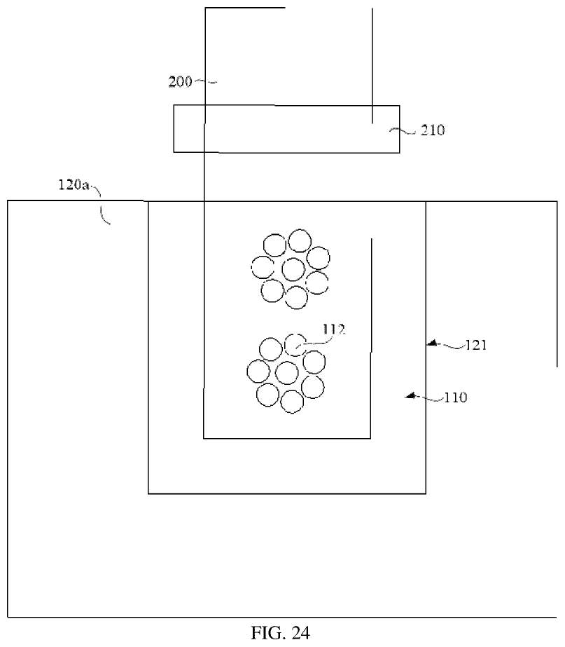

For example, the plurality of welding marks 112 may be distributed within the welding area 111 in a form of a rectangular array shown in FIGS. 21 and 22. The plurality of welding marks 112 may also be distributed within the welding area 111 in a form of a diamond array shown in FIG. 23. The plurality of welding marks 112 may also be distributed within the welding area 111 in a form of a circular array shown in FIG. 24. It should be noted that the several arrangements mentioned above only taken as examples to explain in the embodiment.

Morphology of the welding mark 112 is a protrusion and a recess with an irregular shape, the first protrusion 312a is formed by a part of a protrusion on a side, away from the current collector 110, of the welding mark 112, the first protrusion 312a protrudes from a surface of the tab 200, and a maximum height of the first protrusion 312a beyond the surface of the tab 200 is less than or equal to 50% of a diameter of a circle corresponding to the welding mark 112. A sum of areas of a plurality of first protrusions 312a on one welding mark 112 is less than or equal to 50% of an area of the welding mark 112 on a side away from the current collector 110 (for example, an area of a projection of the welding mark 112 on the tab 200), i.e., a proportion of the areas of the plurality of first protrusions 312a on one welding mark 112 to the area of the one welding mark 112 is greater than or equal to 50%, so that a total area of the protrusions on the welding mark 112 is increased, so as to reduce burrs on a surface of the welding mark 112. With the morphology like this, an overall height of the protrusion is relatively low, and the area of the protrusion is relatively large, which is not easy to pierce a separator, improving a safety performance of a battery.

Therefore, a welding strength between a tab and a current collector can be effectively increased by setting a structure, quantity and an arrangement of the welding mark between the tab and the current collector, improving a reliability of an electrode plate after welding.

In addition, in related technologies, the electrode plate body is provided with a region uncoated with active layer, and an active material layer in the region uncoated with active layer is removed to expose two opposite surfaces of a current collector in the region uncoated with active layer, and the tabs are welded to the current collector in the region uncoated with active layer. When the current collector is connected to the tab, only one surface of the current collector may be used, however, the tab is connected to the current collector in the region uncoated with active layer, so that the active material layers on the two opposite surfaces of the current collector both need to be removed, resulting in more active material layers to be removed, and further affecting an energy density of a battery.

Based on this, another purpose of setting the groove 121 is to reduce the total amount of removed active material layers, so as to improve an energy density of a battery, i.e., only the active material layer 120 on one functional surface of the current collector 110 is removed to connect the tab 200, and the active material layer 120 on a surface, away from the groove 121, of the current collector 110 and directly opposite to the groove 121 is retained, so that the total amount of the removed active material layers 120 may be reduced, improving an energy density of a battery.

As shown in FIGS. 1 and 7, the groove 121 may be close to an edge of the electrode plate body 100 along the width direction of the electrode plate body 100, and a side, close to the edge, of the groove 121 is open. I.e., there is no active material layer 120 on an outer side, close to the edge, of the groove 121, and an outer side, away from the edge, of the groove 121 is provided with the active material layer 120. Along the width direction of the electrode plate body 100, a length of the groove 121 is less than a length of the current collector 110. In addition, outer sides at two ends of the groove 121 along the length direction of the electrode plate body 100 may all be provided with the active material layer 120.

In an example, in one electrode plate 10, two functional surfaces of the current collector 110 may be a first functional surface and a second functional surface, respectively, the first active material layer 120a is disposed on the first functional surface, and the second active material layer 120b is disposed on the second functional surface. The first active material layer 120a is provided with the groove 121, and a bottom wall of the groove 121 is the first functional surface. The second active material layer 120b directly opposite to the groove 121 is retained, and on the current collector 110, a projection of the groove 121 is within a projection of the second active material layer 120b, reducing the total amount of the removed active material layers 120, and further improving an energy density of a battery.

The active material layer 120, corresponding to a position of the groove 121, on the current collector 110 is removed by cleaning, so as to expose the current collector 110, and therefore, the groove 121 is formed. A cleaning method may be laser cleaning, mechanical cleaning, or foaming glue cleaning, which is not limited in the present application.

In an embodiment of the present application, as shown in FIG. 6, a side, away from the current collector 110, of the tab 200 may be covered with a protective layer 40, the protective layer 40 has a fixing effect on the tab 200, and disposal of the protective layer 40 can prevent burrs on the groove 121 and the tab 200 from piercing a separator adjacent to the groove 121 in a battery. The groove 121 is completely covered by the protective layer 40.

In an embodiment of the present application, along the thickness direction of the electrode plate 10 (i.e. the third direction), a depth of the groove 121 ranges from 0.01 mm to 0.2 mm, for example, the depth of the groove 121 may be 0.01 mm, 0.03 mm, 0.04 mm, 0.05 mm, 0.07 mm, 0.1 mm, or 0.2 mm, and the like, which is not limited in the embodiment of the present application. When the depth of the groove 121 is less than 0.01 mm, the active material layer 120 is relatively thin, which leads to a relatively low energy density of a battery. When the depth of the groove 121 is greater than 0.2 mm, the active material layer 120 is relatively thick, which leads to a relatively large thickness of the electrode plate body 100.

Along the width direction of the electrode plate body 10 (i.e., the first direction), a length of the groove 121 ranges from 1 mm to 40 mm, for example, the length may be 1 mm, 2 mm, 5 mm, 10 mm, 15 mm, 20 mm, 30 mm, or 40 mm, and the like, which is not limited in the embodiments of the present application. When the length of the groove 121 is less than 1 mm, the groove 121 is relatively small, which leads to a relatively small area of an exposed functional surface of the current collector 110, resulting in a relatively low connection strength between the tab 200 and the current collector 11. When the length of the groove 121 is greater than 40 mm, the groove 121 is relatively large, resulting in more removal of the active material layer 120, and further greatly affecting an energy density of a battery.

Along the length direction of the electrode plate body 10 (i.e., the second direction), a length of the groove 121 ranges from 1 mm to 30 mm, for example, the length may be 1 mm, 2 mm, 5 mm, 10 mm, 15 mm, 20 mm, 25 mm, or 30 mm, and the like, which is not limited in the embodiments of the present application. A design principle of the length of the groove 121 along the second direction is similar to that of the length of the groove 121 along the first direction, and details are not described again.

In an embodiment of the present application, as shown in FIG. 1, along the second direction, the groove 121 is located in a middle region of the electrode plate body 100 (or the current collector 110, or the electrode plate 10), i.e., a distance L11 from the groove 121 to one end of the electrode plate body 100 (or the current collector 110, or the electrode plate 10) along the first direction is ⅓ to ⅔ of a total length L10 of the electrode plate body 100 (or the current collector 110, or the electrode plate 10). Along the thickness direction of the electrode plate body 100 (i.e., the third direction), a depth of the groove 121 ranges from 0.01 mm to 1 mm; along the length direction of the electrode plate body 10 (i.e., the second direction), a length of the groove 121 ranges from 2 mm to 40 mm; and along the width direction of the electrode plate body 10 (i.e., the first direction), a length of the groove 121 ranges from 2 mm to 30 mm.

In an embodiment of the present application, in order to remove burrs and a residual active material layer 120 at an edge of the groove 121 to prevent the burrs and the residual active material layer 120 from affecting a welding effect of the tab 200, as shown in FIG. 1, a notch 130 is further provided at the edge of the groove 121.

In an example, along the second direction, a length of the notch 130 is 50% to 100% of a length of the groove 121, and along the first direction, a length of the notch 130 is 1% to 50% of the length of the groove 121. In another example, along the second direction, a length of the notch 130 is 80% to 120% of a length of the groove 121, and along the first direction, the length of the notch 130 is 1% to 50% of the length of the groove 121.

In an embodiment of the present application, as shown in FIG. 1 and FIG. 3, the tab 200 is further provided with a tab tape 210, and the tab tape 210 is adhered to two opposite surfaces of the tab 200 for insulating and sealing the tab 200, so as to prevent the tab 200 from being short-circuited.

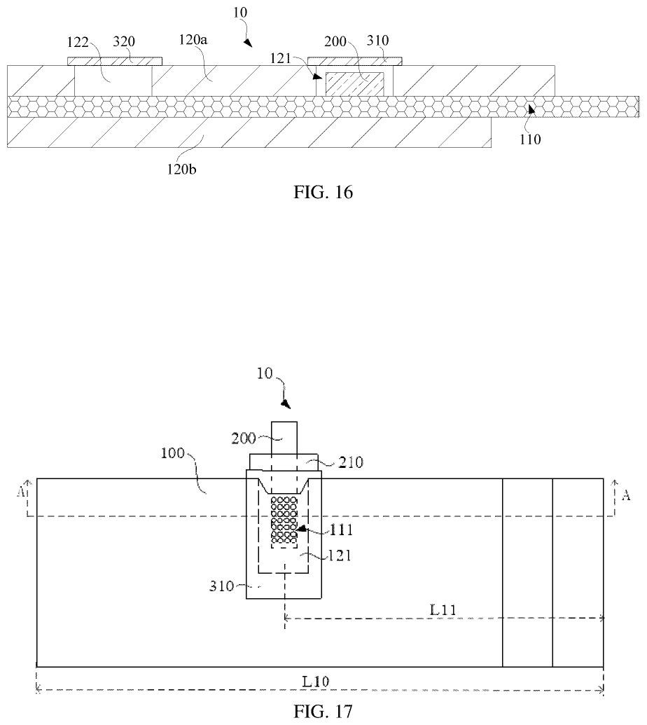

In an embodiment of the present application, as shown in FIG. 15 and FIG. 16, in order to improve an insulation performance at a welding position after the tab 200 is welded, in the present application, a first insulating adhesive layer 310 is attached to a surface of the groove 121. Along the third direction a thickness of the first insulating adhesive layer 310 ranges from 0.001 mm to 0.1 mm, along the first direction, a length of the first insulating adhesive layer 310 is greater than a length of the groove 121, and along the second direction, a length of the first insulating adhesive layer 310 is greater than a length of the groove 121. The purposes of such an arrangement are that the welding area 111, a portion of the tab 200 and an entire groove 121 may be completely covered by the first insulating adhesive layer 310, so that the tab 200 and the current collector 110 inside the groove 121 are completely sealed and insulated, avoiding a risk of a short circuit.

For example, as shown in FIG. 2, in the electrode plate 10 provided in the present application, the groove 121 is located in the first active material layer 120a, and the tab 200 is disposed inside the groove 121. Since the tab 200 is connected to the current collector 110 by laser welding, the second active material layer 120b at a back of the tab 200 may not be affected, so that there is no need to attach an insulating adhesive layer to a side where the second active material layer 120b is located.

In an embodiment of the present application, in order to reduce a thickness of a battery cell formed by winding the electrode plate 10, as shown in FIG. 15 and FIG. 16, another electrode plate 10 is further provided according to the present application, the first active material layer 120a on the current collector 110 has an avoidance groove 122, and the avoidance groove 122 and the groove 121 mentioned above are located on a same side of the first active material layer 120a.

A size of the groove 121 and a size of the avoidance groove 122 are consistent, and an active material coated in a specific region on a surface of the first active material layer 120a may also be scraped by using techniques such as laser cleaning, foaming, or machinery, so as to form the avoidance groove 122.

As shown in FIG. 15, along the second direction, the avoidance groove 122 is located in a middle region of the electrode plate body 100 (or the current collector 110), a distance L12 from the avoidance groove 122 to one end of the electrode plate body 100 (or the current collector 110) is ⅓ to ⅔ of a total length L10 of the electrode plate body 100 (or the current collector 110). Along the first direction, a length of the avoidance groove 122 ranges from 2 mm to 30 mm; along the first direction, a length of the avoidance groove 122 ranges from 2 mm to 40 mm; and along the third direction, a depth of the avoidance groove 122 ranges from 0.01 mm to 1 mm.

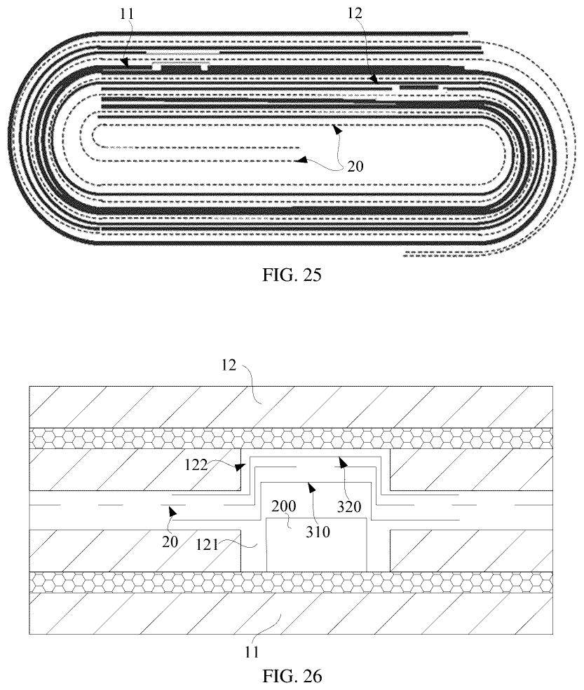

FIG. 25 is a schematic structural diagram of a battery cell according to the present application. As shown in FIG. 25, a battery cell structure according to the present application includes a positive electrode plate 11, a negative electrode plate 12 and a separator 20 that are wound, the separator 20 is located between the positive electrode plate 11 and the negative electrode plate 12, and the positive electrode plate 11 and/or the negative electrode plate 12 are the electrode plate 10 in the above content.

A battery according to the present application includes a housing and the electrode plate 10 in the above. There are two electrode plates 10, the two electrode plates 10 may be a first electrode plate 11 (i.e., a positive electrode plate) and a second electrode plate 12 (i.e., a negative electrode plate), respectively. As shown in FIG. 24, at least one electrode plate 10 has an avoidance groove 122, and the avoidance groove 122 is disposed corresponding to the groove 121 on another electrode plate 10.

Specifically, the positive electrode plate 11 may be the electrode plate 10 shown in FIG. 1 or another electrode plate 10 shown in FIG. 15, and the negative electrode plate 12 may be the electrode plate 10 shown in FIG. 1 or another electrode plate 10 shown in FIG. 15, which is not specifically limited in the present application. The following is explained by taking the positive electrode plate 11 as the electrode plate 10 shown in FIG. 1 and the negative electrode plate as the electrode plate 10 shown in FIG. 15 as an example.

As shown in FIG. 1, FIG. 2 and FIG. 16, ab electrode plate body 100 of the positive electrode plate 11 includes a current collector 110 and an active material layer 120, and the active material layer 120 includes a first active material layer 120a and a second active material layer 120b. The current collector 110 is made of an aluminum (Al) material, and a constituent material of the first active material layer 120a and the second active material layer 120b generally includes a positive electrode active material, an adhesive, and a conductive agent. The positive electrode active material mainly includes at least one of lithium cobalt oxide (LCO), nickel-cobalt-manganese ternary material (NCM), nickel-cobalt-aluminum ternary material (NCA), nickel-cobalt-manganese-aluminum quaternary material (NCMA), lithium iron phosphate (LFP), lithium manganese phosphate (LMP), lithium vanadium phosphate (LVP), lithium manganate (LMO), or a lithium-rich manganese-based material.

In an embodiment, along the third direction, a thickness of the current collector 110 on the positive electrode plate 11 is 0.008 mm.

A tab 200 welded to the electrode plate body 100 of the positive electrode plate 11 is a positive tab, a material of the positive tab is also an aluminum (Al) material, and the positive tab is welded on a welding area 111 in a groove 121 of the positive electrode plate 11 by a laser welding method. A first insulating adhesive layer 310 is attached to a surface of the positive tab after the welding is completed, and a partial surface of the positive tab and the groove 121 are completely covered by the first insulating adhesive layer 310. After the positive tab is electrically connected to an external circuit, the positive electrode (i.e., the positive electrode plate 11) of the battery may be formed.

In an embodiment, a thickness of the positive tab along the third direction is 0.1 mm, a length of the positive tab along the second direction is 6 mm, and a length of an overlapping portion between the positive tab and the current collector 110 along the first direction is 20 mm.

In an embodiment, the groove 121 is obtained by a machinery method, a length of the groove 121 along the second direction is 10 mm, a length of the groove 121 along the first direction is 25 mm, a depth of the groove 121 along the third direction is 0.05 mm, and the positive tab is placed in a middle of the groove 121. Along the second direction, a distance from the groove 121 to one end of the electrode plate 10 is ½ of a total length of the electrode plate 10. The groove 121 is provided with a notch, a shape of a projection of the notch on the groove 121 is trapezoidal, a length of the notch along the second direction is 10 mm, and a length of the notch along the first direction is 2 mm.

In an embodiment, morphology of a welding mark 112 is set to be a circular shape, i.e., a shape of the welding mark 112 is a circle, a diameter of the circle is 0.8 mm, and a distance between two adjacent welding marks 112 is 0.2 mm. A laser power is set to be 30 W, a pulse width is set to be 0.02 ms, and a height of a protrusion on a surface of the welding mark 112 is 20 m after the welding is completed. The number of welding marks 112 is 20, and a sum of areas of protrusions on each of the at least half the number of welding marks 112 accounts for more than 50% of an area of corresponding welding mark 112 (for example, an area of a projection of the welding mark 112 on the tab 200). With the morphology like this, an overall height of the protrusions is relatively low, and the area of the protrusion is relatively large, which is not easy to pierce a separator, improving a safety performance of a battery. Moreover, a welding pulling force reaches 30 N, and therefore, a reliability of the electrode plate 10 is relatively high.

In an embodiment, a length of the first insulating adhesive layer 310 along the second direction is 20 mm, a length of the insulating adhesive layer 310 along the first direction is 30 mm, and a thickness of the insulating adhesive layer 310 along the third direction is 0.012 mm.

As shown in FIG. 15 and FIG. 16, the electrode plate body 100 of the negative electrode plate 12 includes a current collector 110 and an active material layer 120, and the active material layer 120 includes a first active material layer 120a and a second active material layer 120b. The current collector 110 is made of materials such as nickel (Ni), copper (Cu) or copper-plated nickel (Ni-Cu) alloy. A constituent material of the first active material layer 120a and the second active material layer 120b generally includes a negative electrode active material, an adhesive, and a conductive agent, and the negative electrode active material includes at least one of graphite, mesophase carbon microbeads, soft carbon, hard carbon, a silicon material, a silicone material, a silicon carbon material, or lithium titanate.

In an embodiment, a thickness of the current collector 110 on the negative electrode plate 12 along the third direction is 0.008 mm.

A tab 200 welded to the electrode plate body 100 of the negative electrode plate 12 is a negative tab, and the negative tab is also made of materials such as nickel (Ni), copper (Cu) or copper-plated nickel (Ni-Cu) alloy, and the negative tab is welded on a welding area 111 in a groove 121 of the negative electrode plate 12 by a laser welding method. A first insulating adhesive layer 310 is attached to a surface of the negative tab after the welding is completed, and a partial surface of the negative tab and the groove 121 are completely covered by the first insulating adhesive layer 310. After the negative tab is electrically connected to an external circuit, the negative electrode (i.e., the negative electrode plate 12) of the battery may be formed.

In an embodiment, a thickness of the negative tab along the third direction is 0.1 mm, a length of the negative tab along the second direction is 6 mm, and a length of an overlapping portion between the negative tab and the current collector 110 is 20 mm along the first direction.

In an embodiment, the groove 121 is obtained by a machinery method, a length of the groove 121 along the second direction is 10 mm, a length of the groove 121 along the first direction is 25 mm, a depth of the groove 121 along the third direction is 0.05 mm, and the negative tab is placed in a middle of the groove 121. Along the second direction, a distance from the groove 121 to one end of the electrode plate 10 is ½ of a total length of the electrode plate 10. The groove 121 is provided with a notch, a shape of a projection of the notch on the groove 121 is trapezoidal, a length of the notch along the second direction is 10 mm, and a length of the notch along the first direction is 2 mm.

In addition, the avoidance groove 122 is further disposed on the electrode plate body 100 of the negative electrode plate 12, the avoidance groove 122 and the groove 121 of the negative electrode plate 12 are both located on a same side of the electrode plate body 100, and the avoidance groove 122 is disposed on the first active material layer 120a. A surface of the avoidance groove 122 is covered by a second insulating adhesive layer 320, and a size of the second insulating adhesive layer 320 is greater than a size of the avoidance groove 122, ensuring that the avoidance groove 122 is completely covered by the second insulating adhesive layer 320.

FIG. 26 is a schematic diagram of superimposing a positive electrode plate and a negative electrode plate according to the present application. As shown in FIG. 25 and FIG. 26, when the positive electrode plate 11 and the negative electrode plate 12 are wound together with the separator 20 to form a battery cell, a welding portion of the tab 200 on the positive electrode plate 11 corresponds to the avoidance groove 122 on the negative electrode plate 12, i.e., a portion of the avoidance groove 122 on the negative electrode plate 12 corresponds to a position of the first insulating adhesive layer 310 on the positive electrode plate 11. During a winding process, a portion of the first insulating adhesive layer 310 on the positive electrode plate 11 and a portion of the separator 20 corresponding to the avoidance groove 122 on the negative electrode plate 12 may be accommodated inside the avoidance groove 122, effectively avoiding an increase in an overall thickness of a battery cell caused by a superposition of the first insulating adhesive layer 310 and the second insulating adhesive layer 320.

In addition, an arrangement of the first insulating adhesive layer 310 being attached to the tab 200 may prevent burrs at the welding area 111 and an edge of the groove 121 from piercing the separator 20. An arrangement of the second insulating adhesive layer 320 being attached to the avoidance groove 122 may prevent burrs at an edge of the avoidance groove 122 from piercing the separator 20.

It should be noted that in the present application, only one form of the positive electrode plate 11 and the negative electrode plate 12 is used as examples for explanation. It may be understood that, if needed, the avoidance groove 122 may also be provided at a position, corresponding to the negative tab, on the positive electrode plate 11, and specific arrangement manners and functions have been described in detail in the foregoing, which is not repeated here.

In order to explain the battery cell structure more clearly, the present application provides a conventional square lithium-ion battery with a model of 3862A0 (as for a finished battery, a thickness is 3.8 mm, a width is 6.2 mm, and a length is 10 mm) as an example for explanation.

The square lithium-ion battery includes a positive electrode plate, a negative electrode plate, a separator, and an electrolyte. The positive electrode plate includes a positive electrode current collector, a positive electrode active material layer, a positive tab, and a first insulating adhesive layer; the positive electrode tab is provided with a groove (used for welding the positive tab), the positive tab is welded to a surface of the positive electrode current collector in the groove, and the positive tab is connected to the positive electrode current collector by laser welding. Since a positive electrode active material on another side, opposite to the positive tab, of the positive electrode current collector is not affected during a laser welding process, there is no need to adhere an insulating adhesive layer to the positive electrode active material layer on another side, opposite to the positive tab, of the positive electrode current collector, and only a surface of the positive tab needs to be covered by the first insulating adhesive layer.

The negative electrode plate includes a negative electrode current collector, a negative electrode active material layer, a groove (used for welding a negative tab), an avoidance groove (i.e., the avoidance groove provided at a position, corresponding to the positive tab, on the negative electrode plate), a second insulating adhesive layer, a third insulating adhesive layer, and the negative tab. The negative tab is accommodated in the groove, and the groove is covered by the second insulating adhesive layer. A surface of the avoidance groove is covered by the third insulating adhesive layer, and the avoidance groove is used for accommodating the third insulating adhesive layer, the separator, and the first insulating adhesive layer.

Along the third direction, a thickness of the positive electrode current collector is 0.01 mm, and a thickness of the negative electrode current collector is 0.006 mm. A material of the positive tab is aluminum, a thickness of the positive tab along the third direction is 0.1 mm, a length of the positive tab along the second direction is 6 mm, and a length of an overlapping portion between the positive tab and the positive electrode current collector along the first direction is 20 mm. A material of the negative tab is nickel, a thickness of the negative tab along the third direction is 0.1 mm, a length of the negative tab along the second direction is 6 mm, and a length of an overlapping portion between the negative tab and the negative electrode current collector along the first direction is 20 mm.

The positive tab is welded to the positive electrode current collector by laser welding, along the second direction, a length of the welding area 111 at the positive tab is 4 mm, and along the first direction, a length of the welding area 111 at the positive tab is 18 mm. The negative tab is welded to the negative electrode current collector by laser welding, along the second direction, a length of the welding area 111 at the negative tab is 5 mm, and along the first direction, a length of the welding area 111 at the negative tab is 15 mm. An active material layer on a back of the positive/negative tab is in direct contact with the separator.

In addition, the groove on the positive electrode plate is formed by techniques such as laser cleaning, foaming or machinery, a length of the groove along the second direction is 10 mm, a length of the groove along the first direction is 25 mm, and a depth of the groove along the third direction is 0.05 mm. The positive tab is accommodated in a middle of the groove, and along the second direction, a distance from the groove to one end of the positive electrode plate is ½ of a total length of the positive electrode plate.

The groove on the negative electrode plate is formed by techniques such as laser cleaning, foaming or machinery, a length of the groove along the second direction is 10 mm, a length of the groove along the first direction is 25 mm, and a depth of the groove along the third direction is 0.05 mm. The negative tab is accommodated in a middle of the groove, and along the second direction, a distance from the groove to one end of the negative electrode plate is ½ of a total length of the negative electrode plate.

The avoidance groove on the negative electrode plate is formed by techniques such as laser cleaning, foaming, or machinery, a length of the avoidance groove along the second direction is 10 mm, a length of the avoidance groove along the first direction is 25 mm, and a depth of the avoidance groove along the third direction is 0.04 mm. Along the second direction, a distance from the avoidance groove to one end of the negative electrode plate is ¼ of a total length of the negative electrode plate.

It should be noted that the groove on the positive electrode plate is provided with a notch, a shape of a projection of the notch on the groove is trapezoidal, the notch has two side lengths along the width direction of the positive electrode plate (i.e., the first direction), and lengths of the two side lengths are 8 mm and 10 mm, respectively. The notch also has two side lengths along the length direction of the positive electrode plate (i.e., the second direction), and lengths of the two side lengths are both 2 mm. No notch is provided on the groove and the avoidance groove on the negative electrode plate.

A size of the first insulating adhesive layer consists with a size of the second insulating adhesive layer, for example, a length of the second insulating adhesive layer along the second direction is 20 mm, a length of the second insulating adhesive layer along the first direction is 30 mm, and a thickness of the second insulating adhesive layer along the third direction is 0.012 mm. A length of the third insulating adhesive layer along the second direction is 18 mm, a length of the third insulating adhesive layer along the first direction is 28 mm, and a thickness of the third insulating adhesive layer along the third direction is 0.012 mm.

After the positive electrode plate and the negative electrode plate are wound together with the separator to form a jelly roll, the groove of the positive electrode plate, the groove of the negative electrode plate, and an active material layer on another side opposite to the avoidance groove are not covered by an insulating adhesive layer, and may be in direct contact with the separator. After winding and hot pressing, the third insulating adhesive layer, the separator, and the first insulating adhesive layer that are corresponding to the positive tab are entered into the avoidance groove, avoiding an increase in a thickness of a battery.

The present application further provides a battery, which includes the electrode plate in the foregoing content. Specific composition structures and working principles of the electrode plate are described in detail in the foregoing, which is not repeated herein.

In addition, the present embodiment further provides a battery, the battery may include at least two electrode plates 10 stacked with each other and having opposite polarities, a separator 20 is disposed between every two adjacent electrode plates 10, and the separator 20 is used for preventing the battery from being short-circuited caused by a contact between the electrode plates 10 having opposite polarities. The at least one electrode plate 10 is the electrode plate 10 in the above embodiments.

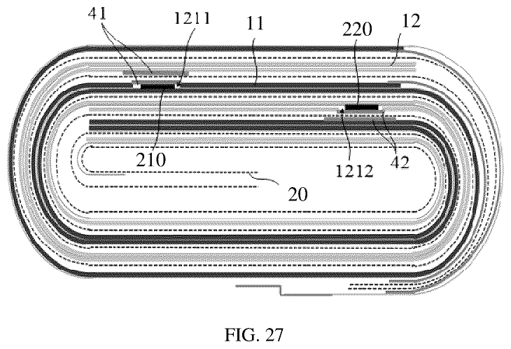

In this embodiment, as shown in FIG. 27, at least two electrode plates 10 include a first electrode plate 11 and a second electrode plate 12 having opposite polarities, the first electrode plate 11 may be a positive electrode plate or a negative electrode plate, and correspondingly, the second electrode plate 12 may be a negative electrode plate or a positive electrode plate.

In some embodiments, the first electrode plate 11 includes a first tab 210, a first current collector, and an active material layer, the active material layer includes a first sub-active material layer and a second sub-active material layer, and a functional surface of the first current collector includes a first sub-functional surface and a second sub-functional surface disposed opposite to each other. The first sub-active material layer is disposed on the first sub-functional surface, and the second sub-active material layer is disposed on the second sub-functional surface; the first sub-active material layer is provided with a first groove 1211, and a bottom wall of the first groove 1211 is the first sub-functional surface; the first tab 210 is electrically connected to the first sub-functional surface in the first groove 1211; and on the first current collector, a projection of the first groove 1211 is within a projection of the second sub-active material layer. A portion, directly opposite to the first groove 1211, of the second sub-active material layer is in contact with the separator 20. In this way, when the first groove 1211 is formed, only a portion of the first sub-active material layer is removed, and the second sub-active material layer on a back surface of the first groove 1211 is retained, so as to improve an energy density of a battery.

In some examples, a first protective layer 41 is disposed between the separator 20 adjacent to the first groove 1211 and the first tab 210. In this way, direct contact between the first tab 210 and the separator 20 adjacent to the first groove 1211 may be avoided, preventing burrs at the first tab 210 (for example, burrs formed by the welding mark) from piercing the separator 20, and further improving safety of a battery. The first protective layer 41 may be disposed on a surface, facing the first groove 1211, of the separator 20, or the first protective layer 41 may be disposed on a surface, facing the separator 20, of the first tab 210.

In some other examples, a first protective layer 41 is provided between the separator 20 adjacent to the first groove 1211 and the second electrode plate 12 adjacent to the separator 20. In this way, direct contact between the second electrode plate 12 adjacent to the separator 20 and the separator 20 may be avoided, preventing a battery from being short-circuited caused by direct contact between burrs and the second electrode plate 12 after the separator 20 is pierced by the burrs, and further improving safety of a battery. The first protective layer 41 may be disposed on a surface, facing the second electrode plate 12, of the separator 20, or the first protective layer 41 may be disposed on a surface, facing the separator 20, of the second electrode plate 12.

In some other examples, a first protective layers 41 may both be disposed between the separator 20 adjacent to the first groove 1211 and the first tab 210, and between the separator 20 adjacent to the first groove 1211 and the second electrode plate 12 adjacent to the separator 20. I.e., there are two first protective layers 41, so as to further improve safety of a battery.

On the first current collector, a projection of the first groove 1211 is within a projection of the first protective layer 41. In this way, the first groove 1211 can be covered by the first protective layer 41, preventing a battery from being short-circuited after the separator 20 is pierced by burrs formed on the first groove 1211 and the first tab 210.

In some embodiments, the second electrode plate 12 includes a second tab 220, a second current collector, and an active material layer, the active material layer includes a third sub-active material layer and a fourth sub-active material layer, and a functional surface of the second current collector includes a third sub-functional surface and a fourth sub-functional surface disposed opposite to each other. The third sub-active material layer is disposed on the third sub-functional surface, and the fourth sub-active material layer is disposed on the fourth sub-functional surface. The third sub-active material layer is provided with a second groove 1212, and a bottom wall of the second groove 1212 is the third sub-functional surface. The second tab 220 is electrically connected to the third sub-functional surface in the second groove 1212. On the second current collector, a projection of the second groove 1212 is within a projection of the fourth sub-active material layer. A portion, directly opposite to the second groove 1212, of the fourth sub-active material layer is in contact with the adjacent separator 20. In this way, when the second groove 1212 is formed, only a portion of the third sub-active material layer is removed, and the fourth sub-active material layer on a back surface of the second groove 1212 is retained, so as to improve an energy density of a battery.

In some examples, a second protective layer 42 is provided between the separator 20 adjacent to the second groove 1212 and the second tab 220. In some other examples, a second protective layer 42 is disposed between the separator 20 adjacent to the second groove 1212 and the first electrode plate 11 adjacent to the separator 20. In some other examples, a second protective layer 42 may be both disposed between the separator 20 adjacent to the second groove 1212 and the second tab 220, and between the separator 20 adjacent to the second groove 1212 and the first electrode plate 11 adjacent to the separator 20. In this way, safety of a battery can be improved. A design principle of the second protective layer 42 is similar to that of the first protective layer 41, and details are not described again.

On the second current collector, a projection of the second groove 1212 is within a projection of the second protective layer 42. In this way, the second groove 1212 can be covered by the second protective layer 42, preventing a battery from being short-circuited after the separator 20 is pierced by burrs formed on the second groove 1212 and the second tab 220.

Specifically, a battery cell in a battery may be formed by the first electrode plate 11, the second electrode plate 12 and the separator 20. The battery cell refers to an electrochemical battery cell containing positive and negative electrode plates mounted inside a battery, the battery cell is generally not directly used, and a battery for charging/discharging may be formed by jointly mounting the battery cell and a protection circuit inside a housing of the battery. Since the battery cell is a power storage portion in a battery, a quality of a battery cell directly determines a quality of a battery.

The battery cell may be a wound battery cell, or may be a laminated battery cell.

In some examples, as shown in FIG. 27, the wound battery cell includes one first electrode plate 11 and one second electrode plate 12. During a winding process, the first electrode plate 11, the separator 20 and the second electrode plate 12 are wound in a same direction from an initial winding end, and finally the wound battery cell is formed.

In some other examples, the laminated battery cell includes a plurality of first electrode plates 11 and a plurality of second electrode plates 12, and in a processing procedure, the first electrode plates 11 and the second electrode plates 12 are alternately stacked in a same direction, meanwhile, the separator 20 is disposed between the first electrode plate 11 and the second electrode plate 12 adjacent to the first electrode plate 11, and finally the laminated battery cell is formed by stacking.

It should be noted herein that a numerical value and a numerical value range involved in the embodiments of the present application are approximate values, and there may be an error in a certain range due to an effect of a manufacturing process, which may be considered to be ignored by those of ordinary skill in the art.

Finally, it should be noted that: above embodiments are merely used to illustrate the technical solutions of the present application, rather than limiting the technical solutions of the present application; although the present application has been described in detail with reference to the foregoing embodiments, it should be understood by those of ordinary skill in the art that it may still modify the technical solutions recited in the foregoing embodiments, or perform equivalent replacement on some or all of the technical features, and these modifications or replacement do not make the essence of the corresponding technical solutions deviate from the scope of the technical solutions of the embodiments of the present application.

What is claimed is:

1. An electrode plate, comprising an electrode plate body and a tab, wherein the electrode plate body comprises a current collector, a first active material layer and a second active material layer, the current collector comprises a first functional surface and a second functional surface that are disposed opposite to each other, the first active material layer is disposed on the first functional surface, and the second active material layer is disposed on the second functional surface; and
the first active material layer is provided with a groove, a bottom wall of the groove is the first functional surface, the tab is welded to the current collector in the groove to form a welding mark, the welding mark comprises a first solder joint and a second solder joint, the first solder joint is located on the tab, the second solder joint is located on the current collector, and the first solder joint and the second solder joint are integrally fused and connected.

2. The electrode plate according to claim 1, wherein at least a part of the first solder joint is located on a surface, away from the current collector, of the tab, and protrudes toward a side away from the current collector to form a first protrusion.

3. The electrode plate according to claim 2, wherein a height of the first protrusion is less than or equal to 0.1 mm along a third direction of the electrode plate.

4. The electrode plate according to claim 2, wherein a shape of the welding mark is a circle, a diameter of the circle ranges from 0.03 mm to 2 mm, and a height of the first protrusion is equal to or less than 50% of the diameter of the circle.

5. The electrode plate according to claim 1, wherein along a third direction of the electrode plate, the first solder joint penetrates through the tab, and the second solder joint penetrates through the current collector; and at least a part of the second solder joint is located on the second functional surface of the current collector and protrudes toward a side away from the tab to form a second protrusion, and the second protrusion is covered by the second active material layer.

6. The electrode plate according to claim 1, wherein the first solder joint comprises a first outer edge portion and a first middle portion, the second solder joint comprises a second outer edge portion and a second middle portion, the first outer edge portion and the second outer edge portion are communicated to form an outer edge portion of the welding mark, the first middle portion and the second middle portion are communicated to form a middle portion of the welding mark, and the outer edge portion is annularly disposed on an outer side of the middle portion; and
along a third direction of the electrode plate, the outer edge portion penetrates through the tab and the current collector, the outer edge portion located on a side of the second functional surface of the current collector protrudes toward a side away from the tab to form a second protrusion, and the second protrusion is covered by the second active material layer.

7. The electrode plate according to claim 1, wherein the first solder joint comprises a first outer edge portion and a first middle portion, the second solder joint comprises a second outer edge portion and a second middle portion, the first outer edge portion and the second outer edge portion are communicated to form an outer edge portion of the welding mark, the first middle portion and the second middle portion are communicated to form a middle portion of the welding mark, and the outer edge portion is annularly disposed on an outer side of the middle portion; and
along a third direction of the electrode plate, the middle portion penetrates through the tab, and the middle portion is located in a partial region, close to the tab, of the current collector.

8. The electrode plate according to claim 1, wherein along a third direction of the electrode plate, the first solder joint penetrates through the tab, and the second solder joint does not penetrate the current collector, and an end portion of the second solder joint is located in a partial region, close to the tab, of the current collector.

9. The electrode plate according to claim 1, wherein the first solder joint comprises a first outer edge portion and a first middle portion, the second solder joint comprises a second outer edge portion and a second middle portion, the first outer edge portion and the second outer edge portion are communicated to form an outer edge portion of the welding mark, the first middle portion and the second middle portion are communicated to form a middle portion of the welding mark, and the outer edge portion is annularly disposed on an outer side of the middle portion; and
along a third direction of the electrode plate, the outer edge portion penetrates through the tab and the current collector, and on the current collector, a projection of the outer edge portion on a side of the second functional surface of the current collector overlaps with a projection of the outer edge portion on a side, away from the current collector, of the tab.

10. The electrode plate according to claim 1, wherein at least a part of the first solder joint is located on a surface, away from the current collector, of the tab and protrudes toward a side away from the current collector to form a first protrusion; at least a part of the second solder joint is located on a second functional surface of the current collector and protrudes toward a side away from the tab to form a second protrusion; and
along a third direction of the electrode plate, a height of the second protrusion is less than or equal to a height of the first protrusion.

11. The electrode plate according to claim 1, wherein along a third direction of the electrode plate, a depth of the second solder joint is 50% to 100% of a thickness of the current collector.

12. The electrode plate according to claim 1, wherein a second direction of the electrode plate is perpendicular to a first direction of the electrode plate, a welding area is provided in the groove, and the welding mark is located in the welding area; and
a size related to the welding area comprises at least one of following sizes:
along the second direction, a length of the welding area being 50% to 100% of a length of the tab; or
along the first direction, a length of the welding region being 50% to 100% of a length of an overlapping portion of the tab and the current collector.

13. The electrode plate according to claim 1, wherein there are a plurality of welding marks, the plurality of welding marks are disposed at intervals to form a welding area, along a third direction of the electrode plate, on a side, away from the current collector, of the tab, a shape of a projection of each of the plurality of welding marks on the tab is spiral; and
on the side, away from the current collector, of the tab, a size related to the plurality of welding marks comprises at least one of following sizes:
the number of spiral lines of each welding mark being 1 to 10;
a distance between any two adjacent welding marks being less than or equal to 5 mm;
in each welding mark, a distance between a spiral center and an outer edge of an outermost spiral line ranging from 0.05 mm to 2.5 mm;
in any one of spiral lines of each welding mark, a ratio of a width of the spiral line to a protrusion height of the spiral line being greater than 1;
in any one of spiral lines of each welding mark, a width of the spiral coil ranging from 0.01 mm to 0.2 mm; or
in each welding mark, a distance between any two adjacent spiral lines ranging from 0.01 mm to 3 mm.

14. The electrode plate according to claim 1, wherein there are a plurality of welding marks, and arrangement of the plurality of welding marks comprises at least one of the following: a rectangular array or a circular array.

15. The electrode plate according to claim 1, wherein a second direction of the electrode plate is perpendicular to a first direction of the electrode plate, a third direction of the electrode plate is perpendicular to both the second direction and the first direction, and a size related to the tab comprises at least one of following sizes:
along the third direction, a thickness of the tab ranging from 0.01 mm to 0.5 mm;
along the second direction, a length of the tab ranging from 1 mm to 12 mm; or
along the first direction, a length of the tab ranging from 5 mm to 50 mm.

16. The electrode plate according to claim 1, wherein along a third direction of the electrode plate, a thickness of the tab is greater than or equal to a depth of the groove.

17. The electrode plate according to claim 1, wherein when the tab is a positive tab, along a third direction of the electrode plate, a thickness of the positive tab is 5 to 20 times a thickness of the current collector; and
when the tab is a negative tab, along the third direction of the electrode plate, a thickness of the negative tab is 10 to 40 times the thickness of the current collector.

18. The electrode plate according to claim 1, wherein a second direction of the electrode plate is perpendicular to a first direction of the electrode plate, a third direction of the electrode plate is perpendicular to both the second direction and the first direction, and a size related to the groove comprises at least one of following sizes:
along the third direction, a depth of the groove ranging from 0.01 mm to 0.2 mm;
along the first direction, a length of the groove ranging from 1 mm to 40 mm; or
along the second direction, a length of the groove ranging from 1 mm to 30 mm.

19. The electrode plate according to claim 1, wherein on the current collector, a projection of the groove is within a projection of the second active material layer.

20. A battery, comprising at least two electrode plates that are stacked on each other, wherein two adjacent electrode plates have opposite polarities, and a separator is provided between every two adjacent electrode plates,
at least one of the at least two electrode plates comprises: an electrode plate body and a tab, the electrode plate body comprises a current collector, a first active material layer and a second active material layer, the current collector comprises a first functional surface and a second functional surface that are disposed opposite to each other, the first active material layer is disposed on the first functional surface, and the second active material layer is disposed on the second functional surface;
the first active material layer is provided with a groove, and a bottom wall of the groove is the first functional surface; and
the tab is welded to the current collector in the groove to form a welding mark, the welding mark comprises a first solder joint and a second solder joint, the first solder joint is located on the tab, the second solder joint is located on the current collector, and the first solder joint and the second solder joint are integrally fused and connected.
